(19) United States
(12) Patent Application Publication
(10) Pub. No.: US 2005/0167450 A1
(43) Pub. Date: Aug. 4, 2005

(54) Cosmetic or dermatological preparation for use with dispenser system

(75) Inventors: Ghita Lanzendorfer, Hamburg (DE); Heidi Riedel, Hamburg (DE); Stephan Ruppert, Hamburg (DE); Michaela Kohut, Hamburg (DE); Claudia Mundt, Bremen (DE); Lorenz Eckers, Tostedt (DE); Frank Hetzel, Welle (DE); Volker Kallmayer, Hamburg (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Beiersforf AG

(21) Appl. No.: 10/990,948

(22) Filed: Nov. 17, 2004

(30) Foreign Application Priority Data
Nov. 17, 2003 (DE) 103 54 053.9

(51) Int. Cl. G01F 11/00

(52) U.S. Cl. 222/257

(57) ABSTRACT

The present invention is a cosmetic or dermatological preparation for use with a dispenser system that includes at least 0.01% by weight of one or more hydrocolloids. The preparation is particularly suitable with a dispenser comprising an essentially cylindrical container and an inner container wall for housing a cosmetic or dermatological preparation; a follow-up plunger on a base side of the dispenser, which is capable of being slidably displaced on the inner container wall under the pressure of the ambient atmosphere; a head section on a top end of the dispenser that can be slidably displaced in relation to the container and that comprises a dispensing channel, the dispensing channel capable of being connected in a communicating manner to the container; a manually actuable delivery device comprising a variable-volume delivery chamber, a delivery element that can be displaced longitudinally in relation to the container and the head section, comprising a delivery plunger that can be slidably displaced within the delivery chamber and a delivery stem connected to the delivery plunger, and a delivery channel circumferentially enclosed by the delivery stem and comprising a delivery-channel inlet opening communicating with the delivery chamber and a delivery-channel outlet opening. The delivery channel outlet opening is capable of being moved into an open position relative to the dispensing channel by displacing the delivery element.

### FIELD OF THE INVENTION

The present invention relates to cosmetic or dermatological preparations which can be applied with the aid of drawing-plunger dispenser systems without the cosmetic properties of these preparations changing to any significant extent.

### BACKGROUND OF THE INVENTION

Dispensers with follow-up plungers which can be displaced for sliding action (and also referred to as drawing-plunger dispensers) and manually actuable delivery devices with a variable-volume delivery chamber are known as supply containers in a large number of use examples, e.g. for body care, in medicine for the application of medicaments or also for the commercial supply of pasty foodstuffs. The configuration of the dispensers used for supplying the very different pasty substances is also correspondingly varied, in particular in respect of the actual delivery and handling mechanism of these dispensers.

Of course, such dispenser systems are suitable, in principle, for the application of cosmetic or dermatological preparations. The drawing-plunger dispensers with self-closing opening which are described in a particular embodiment in WO 03/004374 A1 can advantageously be used for cosmetics in particular because no product residues run out of the dispenser opening following application and unattractive soiling of the dispenser is thus avoided. On the other hand, the cosmetic or dermatological formulations are subjected to a pronounced shearing action as they pass out of the dispenser, on account of the specific construction (sealing lip at the opening), and this shearing action can give rise to a considerable loss in viscosity of the cosmetic preparation. In conjunction with the loss in viscosity, the sensory properties of the preparation usually also change. The cosmetic preparations feel, for example, less rich (aqueous, empty) or disadvantageously thin or give the impression of not providing such good treatment. However, the changes in the properties of the product are subject to considerable fluctuations in dependence on, for example, how forcibly and quickly the dispenser is actuated by the user and the temperature and the initial viscosity of the preparation. As a result, the product properties can only be influenced to a limited extent by the manufacturer such that the user actually obtains, during use, the desired product quality, or one which can be reproduced and remains constant for the entire duration of use and for, as far as possible, all users.

### SUMMARY OF THE INVENTION

It was thus an object of the present invention to avoid the disadvantages of the prior art and to find, in particular, cosmetic or dermatological preparations which have, as far as possible, the same cosmetic properties before and after application with the aid of drawing-plunger dispenser systems. In particular the intention to find preparations which can serve as a basis for types of preparation with a wide variety of application purposes and, furthermore, are distinguished by very good sensory properties, for example spreadability on the skin or the ability to be absorbed in the skin.

It was surprising, and could not be foreseen by the person skilled in the art, that the use of at least 0.01% by weight of one or more hydrocolloids in cosmetic or dermatological preparations for preventing a loss in structure of the preparations as they are removed from dispenser systems in which the preparations are subjected to a shearing action during removal would help to overcome the disadvantages of the prior art.

Preferred dispenser systems in accordance with the present invention are drawing-plunger dispensers, for example the drawing-plunger dispensers described in WO-03/004374-A1.

In a particularly preferred embodiment of the present invention, the dispenser system is designed to the effect that the delivery device comprises a delivery element which can be displaced longitudinally in relation to the container and the head section and has a delivery plunger which can be displaced for sliding action in the delivery chamber and is connected to a delivery stem which circumferentially encloses a delivery channel which has a delivery-channel inlet opening, communicating with the delivery chamber, and a delivery-channel outlet opening which, by virtue of a displacement movement of the delivery element relative to the head section, can be moved into a position in which the delivery-channel outlet opening opens in relation to the dispensing channel.

In the case of the preferred dispenser, the delivery chamber opens in relation to the dispensing channel via a delivery-channel outlet opening which is released via a longitudinal displacement of the delivery element relative to the head section. This relative movement is preferably achieved in that the head section is manually actuated, i.e. is axially displaced for sliding action in the direction of the container. The through-passage of the pasty product from the delivery chamber to the product-discharge opening at the end of the dispensing channel is thus already released by a translatory movement of the head section relative to the delivery element. There is no need for a prior build-up of pressure in the delivery chamber, as was necessary in the case of the generically determinative prior art for the purpose of releasing the through-passage. This results in a reduction in the actuating forces for discharging pasty products from the dispenser.

In the case of the preferred dispenser, a delivery channel enclosed by a delivery stem is provided downstream of the delivery chamber. At the end of this delivery channel, the pasty product delivered out of the delivery chamber is discharged through the delivery-channel outlet opening into the dispensing channel. It is only once the product has been discharged from the delivery-channel outlet opening that it is present in the dispensing channel.

The remaining dispensing channel, in any case, is shorter than in the case of the dispensers which are usually used. Accordingly, a considerably lesser volume of pasty substance is adversely affected by any possible oxidation processes. The remaining length of the dispensing channel can be shortened, in particular in the case of those products which are highly susceptible to oxidation, by the dispensing channel being open in the outward direction in extension of the end side of the head section.

In the case of an advantageous configuration of the preferred dispenser, the delivery-channel outlet opening is made on the circumferential surface of the delivery stem, and a bushing which covers the delivery-channel outlet opening in the starting position of the delivery device is provided on the head section, with the result that, in the case of a displacement movement of the head part in order for pasty substance to be delivered out, release of the delivery-channel outlet opening is easily achieved by the delivery stem being moved relative to the bushing. This preferred configuration is not just straightforward, but also allows the delivery-channel outlet opening to be arranged in the immediate vicinity of the inlet opening of the dispensing channel for the product which is to be delivered.

With regard to good axial guidance of the delivery device relative to the head section, the abovementioned bushing is preferably designed as a guide bushing for the delivery device and has at least one guide surface interacting with the circumferential surface of the delivery stem.

In respect of the delivery-channel outlet opening being forcibly closed when the head section is returned into the starting position, it is proposed, according to a preferred development of the present invention, that provided on the head part and on the delivery device are carry-along means by way of which the delivery device is carried along into the starting position, following manual actuation, when the head part is returned.

The abovementioned carry-along means are easily formed preferably by a carry-along shoulder which is formed on the bushing and interacts with a carry-along ring integrally formed on the delivery stem. This carry-along ring is preferably integrally formed at the end of the delivery stem, with the result that the delivery-channel outlet opening made beneath the carry-along ring can be sealed in the starting position by abutment of the carry-along ring against walls of the head part.

In the case of the preferred configuration mentioned above, the volume present in the dispensing channel can be further reduced by the carry-along shoulder being formed at the end of the bushing, and at the transition to the dispensing channel, and the carry-along ring being formed in the end region of the delivery stem, which is closed at the end, as is proposed according to a preferred development of the present invention. In the case of this preferred configuration, the stem cap, which is arranged at the end of the delivery stem, covers the dispensing channel in an essentially flush manner in the starting position of the delivery device and preferably has the carry-along ring.

According to a preferred development of the present invention, the delivery plunger is preferably actuated via the end surfaces of the guide bushing. In the case of this preferred development, the delivery plunger projects radially beyond the delivery stem in order to form an annular abutment surface for a pressure-exerting surface which is formed on the end side of the guide bushing and which, in the starting position, is spaced apart axially from the abutment surface and, by virtue of the head section being displaced axially in the direction of the container, can be positioned on the abutment surface.

Likewise with regard to a simplification in design, it is proposed, according to a further preferred configuration of the present invention, to form the inner wall of the delivery chamber by an inner sleeve which is provided on the head-section end side of the container. In this case, the inner sleeve projects beyond the end side of the container on the side which is directed towards the head section. In order to reduce the number of components, the inner sleeve is preferably integrally formed on the container.

For straightforward centring of the head section during assembly of the dispenser and easy fastening of the head section on the container, a mating head section is proposed according to a preferred development of the present invention, this mating head section having a retaining cylinder, which is fitted in a cup-like manner onto the abovementioned inner sleeve, and a guide cylinder, which is arranged concentrically in relation to the retaining cylinder and guides the sliding displacement of the head section. The guide cylinder and/or the retaining cylinder allow/allows easy concentric alignment of the head part in relation to the cylinder. Furthermore, the guide cylinder improves the guidance of the displacement movement of the head section during actuation of the dispenser.

In the case of a further preferred configuration of the preferred dispenser, in the case of which the delivery-chamber end of the guide cylinder forms a stop for the delivery plunger, the delivery plunger is guided in a relatively elongate manner on the one hand, and the displacement of the delivery plunger is easily limited, on the other hand. Such a displacement-limiting action secures, for example, the head part in the starting position on the container when the carry-along means are in operative connection.

The retaining cylinder preferably has a base-side annular shoulder which forms an abutment surface for a helical spring which retains the head section under prestressing in the starting position. This provides the advantage that the outer circumferential surface of the retaining cylinder encloses the helical spring on the inside and thus prevents the spring from buckling. In the case of this preferred configuration, the annular shoulder is positioned on the end side of the container and is thus suitable, in particular, for securing the mating head section in the axial direction in relation to the container.

According to a further, particularly preferred configuration, the mating head section and the head section are formed as a prefabricated dispenser component. In this case, the head section and the mating head section particularly preferably have their outer lateral surface pushed over one another in a cup-like manner in each case, the mating head section having at least one stop for limiting the axial displacement movement of the head section relative to the mating head section. In the case of such a configuration, a restoring element, for example the abovementioned helical spring which retains the head section and the mating head section under prestressing at an axial distance apart, is preferably located in the interior enclosed by the lateral surfaces. The abovementioned stop limits the axial displacement movement of the head section, i.e., following assembly of the head section and mating head section with the inclusion of the spring, ensures that the two components, which can be displaced in relation to one another, are held together. The resulting dispenser component can be positioned on containers of different configurations, which allows cost-effective production of the dispenser for very different applications and container volumes.

A particularly straightforward and durable connection between the prefabricated dispenser component and the container is formed by the dispenser component being latched to the container via latching means formed on the mating head section and the end side of the container.

In the case of the preferred dispenser, the head section can preferably be displaced lengthwise such that it can be moved by means of manual actuation from the starting position, in the first instance by a first axial distance in order to butt against the delivery plunger, into a central position, with simultaneous exposure of the delivery-channel outlet opening in the dispensing channel, and it can then be moved, upon continued axial displacement, with the delivery plunger being carried along, from the central position into a final dispensing position, in which the delivery chamber, by virtue of displacement of the delivery plunger, has reached its smallest volume. In the case of this preferred configuration, the operations of exposing the delivery-channel outlet opening and compressing the substance in the delivery channel take place within the framework of the head section moving in the same direction towards the container. This preferred configuration allows a straightforward design solution for the preferred dispenser, in the case of which the head section acts directly on the delivery plunger and drives the latter, following exposure of the delivery-channel outlet opening, in order to deliver pasty substance. This movement of the head section usually takes place counter to the force of a prestressing element, for example of a spring, which ensures that, when the head section is relieved of loading, it pushes away from the container and the final dispensing position. During this movement, first of all the axial distance a is covered, i.e. the delivery-channel outlet opening is closed again. During this closure movement, the delivery stem and the dispensing channel move relative to one another, which results in an increase in the volume of the dispensing channel at its inlet. The pasty substance located in the dispensing channel is thus drawn back in the direction of the pumping chamber, that is to say is moved away from the product-discharge opening of the dispensing channel in the head part.

According to a particularly preferred configuration, a closure part is located at this product-discharge opening. The closure part is preferably of such a nature that it opens in order to discharge the pasty product on account of a difference in pressure between the dispensing channel and the atmosphere. If—as mentioned above—the pasty substance in the dispensing channel is drawn back away from the product-discharge opening, then this results in a relative negative pressure in the dispensing channel, which ensures that the closure part seals the product-discharge opening in a particularly effective manner.

In respect of the best possible sealing, it is preferable to form the product-discharge opening around a closure pin arranged in the dispensing channel.

This closure pin is preferably integrally formed on the head part. The likewise annular closure part has a sealing lip which can be positioned for sealing action on the closure pin and, in the case of an active negative pressure, closes the dispensing channel in an effective manner but, for delivering out the pasty product, releases a comparatively large product-discharge opening through which the product can be delivered out with a relatively low loss in pressure.

A highly effective closure part can be formed in a particularly cost-effective manner on the head part by means of two-component injection moulding, as is proposed according to a preferred development of the present invention. In the case of this configuration, the closure part is fixed to the head part. The closure part is preferably formed from a soft/resilient plastic, particularly preferably from a thermoplastic elastomer. It has been found that effective sealing of the product-discharge opening can be achieved, in particular, by a thermoplastic elastomer.

It has been found that the material for the sealing part can be utilized in a particularly preferable manner for forming a functional surface on the end-side outer surface of the head part. Such a functional surface may be, for example, a pushing surface which improves the haptic properties and against which the user of the dispenser pushes when using the same. Such a functional surface is preferably formed by a coating at least on the end side of the exterior of the head part. The closure part and the coating are formed in one piece, preferably by means of two-component injection moulding following the injection moulding of the head part.

### BRIEF DESCRIPTION OF THE DRAWINGS

Further details, advantages and features of the present invention can be gathered from the following description of an exemplary embodiment in conjunction with the drawing, in which:

FIG. 1 shows a view, in longitudinal section, of a first exemplary embodiment of a preferred dispenser; and

FIG. 2 shows a view, in longitudinal section, of a second exemplary embodiment of a preferred dispenser.

### DETAILED DESCRIPTION OF THE INVENTION

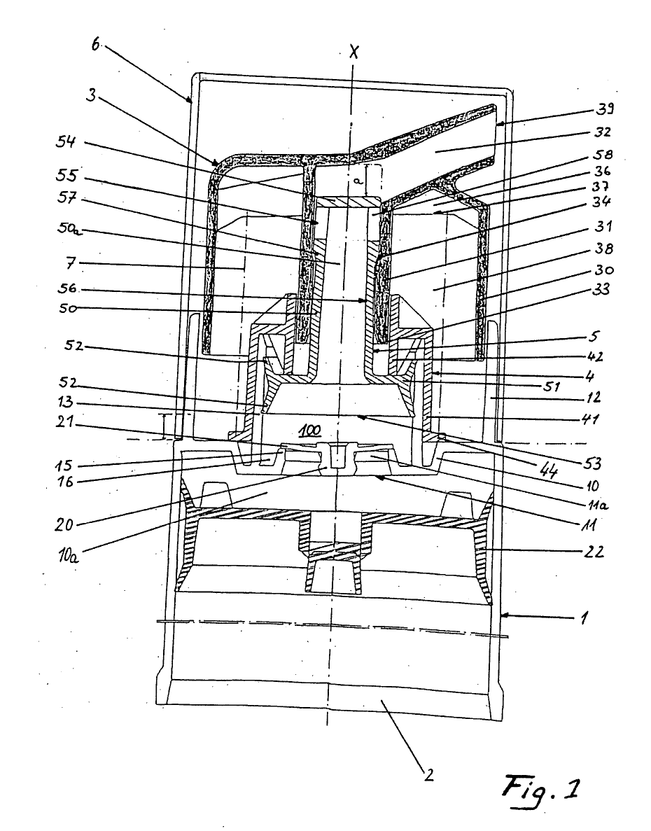

That exemplary embodiment of a preferred dispenser which is shown in FIG. 1 has a container 1 which is of cup-like design and is connected, on its underside, to a base plate 2 which is latched to the container 1. On its other end side, the container 1 has a head-side covering 10, in which a container opening 11 is made. This covering 10, on the side which is directed away from the container 1, is formed for accommodating a dispenser head, comprising a head section 3, a mating head section 4 and a pressure-exerting plunger 5. The dispenser also has a closure cap 6 pushed onto an outer sleeve 12 of the container 1, the outer sleeve extending above the covering 10. The container 1, the base plate 2, the mating head section 4 and the pressure-exerting plunger 5 are designed as rotationally symmetrical components and are arranged concentrically in relation to a centre longitudinal axis X. Located between the head section 3 and the mating head section 4 is a schematically indicated helical spring 7 by means of which the head section 3 is retained in a prestressed state in relation to the mating head section 4 in the starting position shown in FIG. 1.

The head section 3 has a cylindrical outer shell 30, which is arranged radially within, and directly adjacent to, the outer sleeve 12 of the container 1 and concentrically in relation to the same. The outer sleeve 12 of the container 1 projects axially beyond the container end of the outer shell 30. Accordingly, that exemplary embodiment of the dispenser which is shown in FIG. 1, even with the closure cap removed, appears as a closed unit comprising the container 1 and the head section 3. As is explained in more detail hereinbelow, the head section 3 and the pressure-exerting plunger 5 are retained in a longitudinally displaceable manner in relation to the container 1, the pressure-exerting plunger 5, furthermore, being longitudinally displaceable in relation to the head section 3.

The cylindrical wall of the container 1 encloses an interior 10a for accommodating the cosmetic or dermatological preparation in accordance with the present invention. Retaining crosspieces 11a which are oriented in the form of a star extend in the container opening 11. On that side of the covering 10 which is directed away from the interior 10a, a cylindrical inner sleeve 13 is arranged concentrically in relation to the container opening 11, has the outer sleeve 12 projecting axially beyond it and encloses a delivery chamber 100. The inner wall of the inner sleeve 13 is smooth. The base of the delivery chamber 100 is formed by the covering 10 of the container 1. The covering 10 has an annular ring 15 which projects into the delivery chamber 100, encloses the container opening 11 and forms an annular gap 16 between itself and the inner sleeve 13.

The pressure-exerting plunger 5 has an essentially cylindrical, internally hollow delivery stem 50 with a delivery plunger 51 integrally formed at one end. The delivery plunger 51 projects radially beyond the delivery stem 50 and has, on its outer circumferential surface, respective top and bottom sealing lips 52 which project axially beyond the essentially annular delivery plunger 51. On an end side which is directed towards the delivery stem 50, the delivery plunger 51 forms an annular abutment surface.

The delivery stem 50 has, at one end, a delivery-channel inlet opening 53 which is made in the centre of the annular delivery plunger 51. At its other end, the delivery stem 50 is closed on the end side by a stem cap 54. The stem cap 54 covers a cylinder portion 55 of the delivery stem 50, this portion having a larger diameter than the rest of the stem region 56. An obliquely outwardly inclined carry-along ring 57 is located between this stem region 56 and the cylinder portion 55. Between the carry-along ring 57 and the stem cap 54, a plurality of delivery-channel outlet openings 58 are distributed over the outer circumferential surface of the cylinder portion 55. Retaining crosspieces, which bear the stem cap 54, extend in the circumferential direction between the delivery-channel outlet openings 58. The delivery-channel inlet opening 53 communicates with the delivery-channel outlet openings 58 via a delivery channel 50a enclosed by the delivery stem 50, and forms a delivery passage for the pasty substance which is free of non-return valves.

The head section 3 has a cylindrical outer shell 30 with an internally hollow guide bushing 31 arranged concentrically in relation to it, this guide bushing communicating with a dispensing channel 32. The end of the guide bushing 32 forms an end-side pressure-exerting surface 33, which has the outer shell 30 projecting axially beyond it. The guide bushing 31 has, adjacent to the end-side pressure-exerting surface 33, a first bushing portion, which has a smaller internal diameter than the second bushing portion, which is located behind the first as seen in the delivery direction of the pasty substance. Formed between the first and the second bushing portions is a carry-along shoulder 34, which connects the two different bush-diameter portions to one another via a slope. The second bushing portion opens out into a dispensing channel 32, which projects laterally from the centre longitudinal axis X.

Approximately at right angles to the centre longitudinal axis X, the head section 3 has spring-abutment surfaces 37 formed on ribs 36. The ribs 36 extend approximately in the form of a star from the bushing 31 to the inner surface of the outer shell 30. Accordingly, an annular space 38 which is open towards the underside of the head section 3 is formed between the inner surface of the outer shell 30, the outer surface of the guide bushing 31 and the spring-abutment surfaces 37.

The head part 3 is opened towards the container side of the outer shell 30 and, above this end side, is formed essentially in the manner of a cap. A product-discharge opening 39 of the dispensing channel 32 is located on the top side of the head part 3, the top side being directed away from the end side of the outer shell 30.

The mating head section 4 has essentially two concentric cylinder portions, namely an outer retaining cylinder 41 and a smaller-diameter guide cylinder 42. The retaining cylinder 41 projects beyond the guide cylinder 42 on the side which is directed towards the container 1, whereas the guide cylinder 42 projects beyond the retaining cylinder 41 on the other side. Provided on that end side of the retaining cylinder 41 which is directed away from the container 1 is an annular crosspiece which extends radially inwards from there and butts approximately centrally against the outer surface of the guide cylinder 42.

The retaining cylinder 41 has an outwardly projecting encircling annular shoulder on its container end side. The container end side of the guide cylinder 42 forms a delivery-plunger stop.

In the assembled state, the delivery plunger 51 of the pressure-exerting plunger 5 is located for sliding displacement in the inner sleeve 13 of the container 1 and thus covers the delivery chamber 100 on the end side. The mating head section 4 is arranged concentrically in relation to the inner sleeve 13 and has its retaining cylinder 41 pushed in a cup-like manner over the inner sleeve 13. The annular shoulder of the mating head section 4 butts against that end side of the covering 10 which is directed away from the container 1.

The annular shoulder of the mating head section 4 is located approximately in the region of the end of the inner sleeve 13. The radially inwardly adjoining guide cylinder 42 encloses the end of the guide bushing 31 of the head part 3. Located radially within this guide bushing 31 is the delivery stem 50 with its smaller-diameter stem region 56. The delivery plunger 51 of the pressure-exerting plunger 5 is arranged for sliding displacement on the inner wall of the inner sleeve 13. The annular abutment surface of the delivery plunger 51 butts against the end side of the delivery-plunger stop of the guide cylinder 42. This retains the prestressing force to which the head section 3 is subjected by the spring 7 and which, via the abutment of the carry-along shoulder 34 and carry-along ring 57, prestresses the pressure-exerting plunger 5 in a direction away from the container 1.

Located between the delivery chamber 100 and the interior 10a of the container 1 is a container valve 20 which is designed in a manner known per se, butts, by way of its sealing washer 21, against the annular ring 15 of the covering 10 and seals the interior 10a in relation to the delivery chamber 100.

When not in use, the dispenser is located in the starting position (0). During use of the dispenser, a user pushes the head section 3 in the direction of the container 1. On account of the incompressibility of the substance contained in the delivery chamber 100 and the delivery channel 50a, the pressure-exerting plunger 5 remains in position. The head section 3 moves relative to the pressure-exerting plunger 5 in the direction of the container 1. The form-fitting abutment between the carry-along ring 57 and the carry-along shoulder 34 is released until the stem cap 54 strikes against the inner surface of the bushing head 35 or—depending on the configuration—the end-side pressure-exerting surface 33 at the end of the guide bushing 31 ends up in abutment against the annular abutment surface 51a of the delivery plunger 51 (central position M). Following this axial displacement by the displacement distance a, the delivery-channel outlet openings 58 are exposed in the dispensing channel 32.

In the case of this as with any other axial relative movement between the head section 3 and the mating head section 4 and/or between the head section 3 and the container 1, the head section 3 is guided for sliding action by the abutment of the outer circumferential surface of the guide bushing 31 against the inner circumferential surface of the guide cylinder 42. The relative movement between the head section 3 and the pressure-exerting plunger 5 is guided via the abutment of the circumferential surface of the second stem portion against the stem region 56.

As the movement of pushing the head section 3 in the direction of the container 1 continues, the pressure-exerting plunger 5 is carried along. The volume of the delivery chamber 100 decreases here, with the result that the pasty product located downstream of the container valve 30, as seen in the conveying direction, is discharged via the delivery-channel outlet opening 58 in the dispensing channel 32. The pasty product leaves the dispensing channel via the product-discharge opening 39 of the same.

At the end of this relative movement of the head section 3 in the direction of the container 1, the container-side sealing lips 52 of the pressure-exerting plunger 5 strike against the end side of the annular gap 16. In this final dispensing position V, the delivery chamber 100 has reached its smallest volume.

If the head section 3 is then released by the user, the helical spring 7 pushes the head section 3 back in the opposite direction. In the first instance here, the pressure-exerting plunger 5 remains in its final dispensing position V. It is merely the head section 3 which moves away from the container 1, to be precise until the carry-along shoulder 34 ends up in abutment against the carry-along ring 57.

During this axial displacement by the distance a, the pasty product located in the dispensing channel 32 is drawn back into the space formed between the stem cap 54 and the inside of the bushing head 35. Thereafter, at the end of this displacement movement, the pasty product no longer butts directly against the product-dispensing opening 39 of the dispensing channel 32, this preventing the situation where pasty product drips out of the dispensing channel 32 at the end of the delivery operation or is adversely affected by soiling in the region of the product-dispensing opening 39.

Following the displacement by the distance a and the abutment of the carry-along ring 57 and carry-along shoulder 34, the pressure-exerting plunger 5 is also moved back, as movement of the head section 3 continues, in the direction of the starting position, which is reached when the delivery-plunger stop butts against the annular abutment surface of the delivery plunger 51. In the case of the relative movement of the pressure-exerting plunger 5 away from the container 1, pasty product is delivered out of the interior 10a of the container 1, through the container opening 11, into the delivery chamber 100. The relative negative pressure produced in the interior 10a here results, in a manner known per se, in a follow-up movement of the follow-up plunger 22 located in the interior 10a.

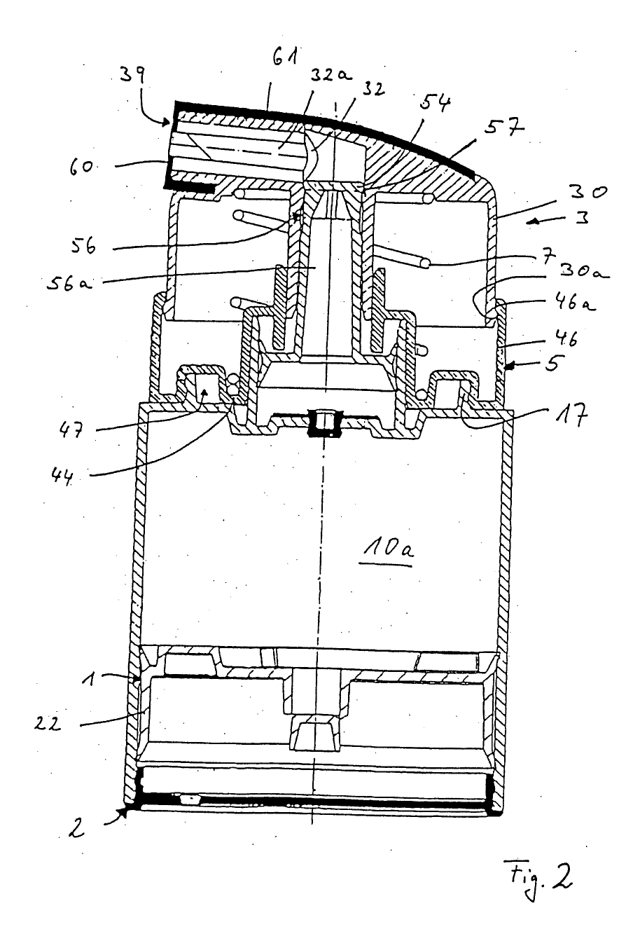

FIG. 2 shows a second exemplary embodiment of a preferred dispenser.

Parts for this exemplary embodiment which are the same as those for the previously discussed exemplary embodiment are provided with the same designations. The container 1 of the exemplary embodiment which is shown in FIG. 2 is designed essentially identically to the abovedescribed container, with an outer container wall which encloses an interior 10a in which a follow-up plunger 22 is arranged in a longitudinally displaceable manner and which is closed by a base plate 2. In contrast to the abovedescribed exemplary embodiment, the container 1 has an encircling latching ring 17 on its end-side covering. The mating head section 4 is extended radially outwards beyond the annular shoulder 44 and has a cylindrical outer wall 46 which extends essentially parallel to the retaining cylinder 51 and of which the diameter is larger than the diameter of the outer shell 30 of the head section 3. A latching recess 47 is formed between the outer wall 46 and the retaining cylinder 41, on the underside of the mating head section 4, the underside being directed towards the container, and interacts with the latching ring 17 in order to form a latching connection between the mating head section 4 and the container 1.

In the case of the exemplary embodiment which is shown in FIG. 2, the mating head section 4 is formed, together with the head section 3, as a prefabricated dispenser component. The free end of the outer wall 46 of the mating head section 4, this free end being directed away from the container 1, is angled radially inwards in order to form a latching nose 46a and projects axially beyond an annular bead 30a which is provided on the outside of the outer shell 30 of the head section 3. This results in the formation of a stop by means of which the mating head section 4 is connected in captive fashion to the head section 3. This stop retains the spring forces applied by the spring 7. The dispenser component comprising the head section 3 and the mating head section 4 can thus be pre-assembled prior to being fitted onto the container 1. For this purpose, the spring 7 is inserted into the cavity between the head section 3 and the mating head section 4. The two components 3, 4 are pushed axially one inside the other until the annular bead 30a has slid past the inwardly bent-over end of the outer wall 46.

In the case of the exemplary embodiment which is shown in FIG. 2, the pressure-exerting plunger 5 has a carry-along ring 57 which is integrally formed on the stem cap 54. Accordingly, in the case of the starting position which is shown in FIG. 2, the carry-along ring 57 seals the dispensing channel 32. The delivery stem 50 has a stem region 56 of reduced diameter, the longitudinal extent of this stem region corresponding to the axial distance a. Accordingly, the axial displaceability of the pressure-exerting plunger 5 in relation to the head part 3 is defined by the stem cap 54, on the one hand, and the longitudinal extent of the stem region 56 of reduced diameter, on the other hand.

The exemplary embodiment which is shown in FIG. 2 has the further difference, in relation to the first exemplary embodiment mentioned above, that the dispensing channel 32 contains a closure pin 32a which is integrally formed on the head section 3. The product-discharge opening 39 encloses the closure pin 32a in an annular manner. In the case of the exemplary embodiment shown, the product-discharge opening 39 is covered by an annular closure part 60 which is connected to the head section 3 as a separate component made of a thermoplastic elastomer. In the starting position in FIG. 2, the closure part 60 butts against the outer circumferential surface and against parts of the end side, but in particular the circumferential surface, of the closure pin 32a and thus seals the dispensing channel 32. A coating 61 is formed integrally with the closure part 60, this coating being made of the same material as the closure part 60 and extending over a large part of the end-side covering of the head section 3. This coating 61 forms a non-slip functional surface on the head section 3.

When the dispenser which is shown in FIG. 2 is actuated, the operations explained above, in particular with reference to FIG. 1, take place. The difference here from the abovementioned exemplary embodiment, however, is that, when the pressure-exerting plunger 5 and head section 3 are returned, the dispensing channel is sealed in relation to the surroundings. In the case of the pressure-exerting plunger 5 moving relative to the head section 3 in the direction of the container 1, the product located in the dispensing channel 32—as has already been mentioned above—is drawn back into the interior of the head section 3 counter to the delivery direction. In the case of the exemplary embodiment which is illustrated in FIG. 2, the pressure gradient which is produced here between the atmosphere and the dispensing channel 32 results in the closure part 60 butting with full sealing action against the surfaces of the closure pin 32a. Accordingly, pasty product present in the dispensing channel 32 remains virtually unaffected by any possible oxidation processes. In addition, the stem cap 54 seals the delivery channel 50a in relation to the dispensing channel 32, with the result that, in particular, the situation where pasty product located in the delivery channel 50a is adversely affected by air possibly penetrating into the dispensing channel 32 is always avoided.

The two exemplary embodiments described above both have the advantage that the delivery-channel openings 58 are only exposed in the dispensing channel 32 following a relative movement between the head part 3 and the pressure-exerting plunger 5. It is not necessary, in order to deliver the pasty product out of the delivery chamber in the direction of the product-discharge opening 39, for the initially built-up internal pressure in the delivery chamber 100 to be utilized for opening a downstream non-return valve, as seen in the conveying direction. Accordingly, the pasty product can be delivered out with a lower level of force being applied. The two exemplary embodiments mentioned above also have the advantage that the pasty product is drawn back in the dispensing channel 32 counter to the conveying direction following the actuation of the head section, the exemplary embodiment which is shown in FIG. 2 having the admissible advantage that, by virtue of the closure part 60 butting with sealing action against the closure pin 32a, the pasty product contained in the dispenser is reliably protected against being adversely affected, for example, by oxygen in the air.

List of Designations:

1 Container
2 Base plate
3 Head section
4 Mating head section
5 Pressure-exerting plunger
6 Closure cap
7 Helical spring
10 Covering
10a Interior
11 Container opening
11a Retaining crosspiece
12 Outer sleeve
13 Inner sleeve
15 Annular ring
16 Annular gap
17 Latching ring
20 Container valve
21 Valve washer
22 Follow-up plunger
30 Outer shell
30a Annular bead
31 Guide bushing
32 Dispensing channel
32a Closure pin
33 Pressure-exerting surface
34 Carry-along shoulder
36 Rib
37 Spring-abutment surface
38 Annular space
39 Product-discharge opening
41 Retaining cylinder
42 Guide cylinder
44 Annular shoulder
46 Outer wall
46a Latching nose
47 Latching recess
50 Delivery stem
50a Delivery channel
51 Delivery plunger
52 Sealing lips
53 Delivery-channel inlet opening
54 Stem cap
55 Cylinder portion
56 Stem region
57 Carry-along ring
58 Delivery-channel outlet
60 opening
61 Closure part
100 Coating Delivery chamber

The present invention thus also relates to cosmetic products comprising
a. a dispenser for pasty products having an essentially cylindrical container (1) which contains the pasty product, has, on the base side, a follow-up plunger (22), which can be displaced for sliding action on an inner container wall under the pressure of the ambient atmosphere, and bears, at its top end, a head section (3) which can be displaced for sliding action in relation to the container (1), has a dispensing channel (32) for the product, it being possible for this dispensing channel to be connected in a communicating manner to the container (1), and acts on a manually actuable delivery device with a variable-volume delivery chamber (100) for the product, characterized in that the delivery device comprises a delivery element (5) which can be displaced longitudinally in relation to the container (1) and the head section (3) and has a delivery plunger (51) which can be displaced for sliding action in the delivery chamber (100) and is connected to a delivery stem (50) which circumferentially encloses a delivery channel (50a) which has a delivery-channel inlet opening (53), communicating with the delivery chamber (100), and a delivery-channel outlet opening (58) which, by virtue of a displacement movement of the delivery element (5) relative to the head section (3), can be moved into a position in which the delivery-channel outlet opening (58) opens in relation to the dispensing channel (32), and
b. cosmetic or dermatological preparations containing at least 0.01% by weight of one or more hydrocolloids.

The cosmetic products according to the present invention constitute, from any point of view, extremely satisfactory preparations which are distinguished in that, once it has passed out of the dispenser opening, the cosmetic or dermatological preparation has the same cosmetic properties (e.g. spreadability on the skin, etc.) as before the dispenser was used, and that any possible slight changes in the properties of the preparation are not perceptible or palpable to the user. The change in viscosity of the cosmetic or dermatological preparation (before and after removal from the dispenser) is advantageously less than 75%, advantageously less than 60%, and particularly advantageously less than 50%.

The products according to the invention are quite particularly suitable for serving as a basis for types of product with a wide variety of application purposes.

“Hydrocolloid” is the technical abbreviation for the per se more correct name “hydrophilic colloid”. Hydrocolloids, also called thickeners or gel formers, are macromolecules which have a largely linear configuration and have intermolecular forces of interaction which permit secondary and primary valency bonds between the individual molecules and thus the formation of a reticular structure. They are sometimes water-soluble natural or synthetic polymers which form gels or viscous solutions in aqueous systems. They increase the viscosity of water by either binding water molecules (hydration) or else by absorbing and encapsulating the water into their interwoven macromolecules, at the same time as restricting the mobility of the water. Such water-soluble polymers represent a large group of chemically very different natural and synthetic polymers whose common feature is their solubility in water or aqueous media. A prerequisite for this is that these polymers have a number of hydrophilic groups sufficient for solubility in water and are not too greatly crosslinked. The hydrophilic groups may be nonionic, anionic, or cationic in nature, for example as follows:

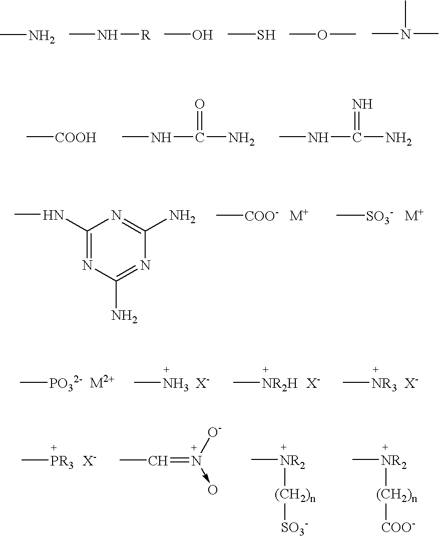

The group of cosmetically and dermatologically relevant hydrocolloids can be divided as follows into organic, natural compounds, such as, for example, agar agar, carrageen, tragacanth, gum arabic, alginates, pectins, polyoses, guar flour, carob bean flour, starch, dextrins, gelatin, casein, organic, modified natural substances, such as, for example carboxymethylcellulose and other cellulose ethers, hydroxyethylcellulose and hydroxypropylcellulose and the like, organic, completely synthetic compounds, such as, for example, polyacrylic and polymethacrylic compounds, vinyl polymers, polycarboxylic acids, polyethers, polyimines, polyamides, inorganic compounds, such as, for example, polysilicic acids, clay minerals, such as montmorillonites, zeolites, and silicas.

Hydrocolloids which may be used advantageously according to the invention are agar agar, carrageen, tragacanth, gum arabic, alginates, pectins, polyoses, guar flour, carob bean flour, starch, dextrins, gelatin, casein, cellulose ethers, hydroxyethylcellulose and hydroxypropylcellulose derivatives, polyacrylic and polymethacrylic compounds, vinyl polymers, polycarboxylic acids, polyethers, polyimines, polyamides, polysilicic acids, clay minerals, zeolites, silicas.

Hydrocolloids preferred according to the invention are, for example, also alkyl-modified cellulose derivatives and alkylhydroxycelluloses, such as, for example, methylcelluloses, which is the term used to refer to the methyl ethers of cellulose. They are characterized by the following structural formula 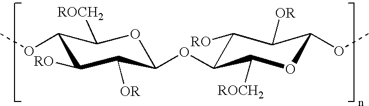
in which R may be a hydrogen or a methyl group.

Of particular advantage for the purposes of the present invention are the cellulose mixed ethers, which are generally likewise referred to as methylcelluloses and which, besides a dominant content of methyl groups, additionally contain 2-hydroxyethyl, 2-hydroxypropyl or 2-hydroxybutyl groups. Particular preference is given to (hydroxypropyl)methylcelluloses, for example those available under the trade name Methocel E4M from Dow Chemical Comp.

Also advantageous according to the invention is sodium carboxymethylcellulose, the sodium salt of the glycolic acid ether of cellulose for which R in structural formula I may be a hydrogen and/or CH₂—COONa. Particular preference is given to the sodium carboxymethylcellulose available under the trade name Natrosol Plus 330 CS from Aqualon, which is also referred to as cellulose gum.

Microcrystalline cellulose is also an advantageous hydrocolloid for the purposes of the present invention. It is obtainable, for example, from the “FMC Corporation Food and Pharmaceutical Products” under the trade name Avicel®. A particularly advantageous product for the purposes of the present invention is the Avicel® grade RC-591, which is modified microcrystalline cellulose which is composed of 89% of microcrystalline cellulose and 11% of sodium carboxymethylcellulose. Further advantageous commercial products of this class of raw materials are Avicel® RC/CL, Avicel® CE-15, Avicel® 500.

Also preferred for the purposes of the present invention is xanthan (CAS No. 11138-66-2), also called xanthan gum. An advantageous hydrocolloid for the purposes of the present invention is also carrageen, a gel-forming extract with a similar structure to agar from North Atlantic red algae, which belong to the Florideae (Chondrus crispus and Gigartina stellata).

The term carrageen is often used for the dried algae product and carrageenan for the extract from this.

Advantageous hydrocolloids for the purposes of the present invention are also derivatized gums, such as, for example, hydroxypropylguar (Jaguar® HP 8) hydroxypropylguar.

Chitosan is also an advantageous hydrocolloid for the purposes of the present invention. Chitosan is characterized by the following structural formula: 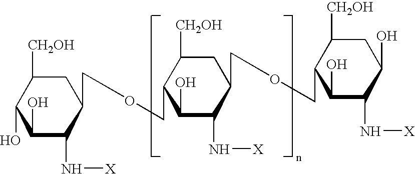
where n assumes values up to about 10 000 and X is either the acetyl radical or hydrogen.

Preference is given according to the invention to chitosans with a degree of deacetylation of >25%, in particular >55 to 99% [determined by means of ¹H NMR].

It is advantageous to choose chitosans with molecular weights between 10 000 and 1 000 000, in particular those with molecular weights between 100 000 and 1 000 000 [determined by means of gel permeation chromatography].

Advantageous hydrocolloids for the purposes of the present invention are also starches, for example from maize, wheat, potatoes, tapioca and rice. Starch consists of amylose (in an amount of about 20 to 30%) and amylopectin (in an amount of about 70 to 80%). Since amylose in particular is suitable as hydrocolloid for the purposes of the present invention, it is advantageous to use plant extracts which have an increased amylose content. Advantageous hydrocolloids for the purposes of the present invention are also modified starches and starch derivatives. These include crosslinked, oxidized, acetylated, hydroxypropylated and partially hydrolysed starch molecules.

Also particularly advantageous are pregelatinized, crosslinked starch derivatives, such as hydroxypropyl starch phosphate, and hydroxypropylated phosphate esters. They are generally “prepasted” and are largely in the form of “agglomerated” starch particles. Due to this pretreatment, hydroxypropyl starch phosphate and esters thereof is completely soluble in cold water, nonionic, can preferably be used in the alkaline pH range, but can also be used in a broader pH range. Hydroxypropyl starch phosphates and esters which are advantageous according to the invention are available under the trade name Structure ZEA, Structure XL from National Starch.

Polyacrylates are gelling agents likewise to be used advantageously for the purposes of the present invention. Polyacrylates advantageous according to the invention are acrylate-alkyl acrylate copolymers, in particular those chosen from the group of so-called carbomers or carbopols (Carbopol® is actually a registered trade mark of NOVEON Inc.). In particular, the acrylate-alkyl acrylate copolymers advantageous according to the invention are characterized by the following structure: 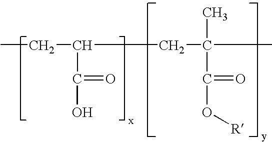
where R′ is a long-chain alkyl radical and x and y represent numbers which symbolize the respective stoichiometric proportion of the particular comonomers.

According to the invention, preference is given to acrylate copolymers and/or acrylate-alkyl acrylate copolymers which are available under the trade names Carbopol® 1382, Carbopol® 981 and Carbopol® 5984, Aqua SF-1 from NOVEON Inc. and as Aculyn® 33 from International Specialty Products Corp.

Also advantageous are copolymers of C10-30-alkyl acrylates and one or more monomers of acrylic acid, of methacrylic acid or esters thereof.

Compounds which carry the INCI name “Acrylates/C 10-30 Alkyl Acrylate Crosspolymer” are advantageous. Particularly advantageous are those polymers available under the trade names Pemulen TR1 and Pemulen TR2 and Carbopol 1328, Ultrez 10, Ultrez 21 from NOVEON Inc., and those available under the trade name Tegocarbomer TC 341 ER from Goldschmidt/Degussa.

Further advantageous hydrocolloids for the purposes of the present invention are so-called AMPS polymers and copolymers, which can be prepared by free-radical polymerization or copolymerization of acrylamidomethylpropylsulphonic acid and optionally one or more olefinically unsaturated comonomers which contain oxygen, nitrogen, sulphur, phosphorus, silicon, chlorine and/or fluorine, and optionally with further macromonomers containing an end group capable of polymerization and an optional hydrophilic moiety which is based, for example, on polyalkylene oxides, and an optionally hydrophobic moiety, which contains hydrogen or a saturated or unsaturated, linear or branched, aliphatic, cycloaliphatic or aromatic (C₁-C₃₀)-hydrocarbon radical. The monomer distribution in the polymers may here be, for example, alternating, block-like (including multiblock) or else random (including gradient). The polymers generally have a number-average molecular weight of from 1000 to 20 000 000 g/mol, preferably 20 000 to 5 000 000, particular preferably 100 000 to 1 500 000 g/mol.

In a preferred embodiment, the AMPS polymers are crosslinked, i.e. they contain at least one crosslinker with at least two double bonds which is polymerized into the polymer. Suitable crosslinkers are, in particular, methylenebisacrylamide and -methacrylamide, esters of unsaturated mono- or polycarboxylic acids with polyols, e.g. diacrylates or triacrylates, such as, for example, butanediol and ethylene glycol diacrylate or methacrylate and trimethylolpropane triacrylate, allyl compounds, such as, for example, allyl(meth)acrylate, triallyl cyanurate, maleic diallyl ester, polyallyl ester, tetraallyloxyethane, triallylamine, tetraallylethylenediamine, allyl esters of phosphoric acid and/or vinylphosphonic acid derivatives.

Compounds which are advantageous according to the invention are, for example, the ammonium acryloyidimethyltaurates/vinylpyrrolidone copolymers (empirical formula [C₇H₁₆N₂SO₄]ₙ[C₆H₉NO]ₘ), which corresponds to the following statistical structure:

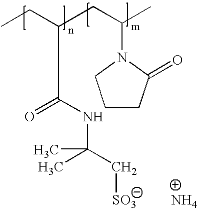

Preferred species for the purposes of the present invention are listed in the Chemical Abstracts under the registry numbers 58374-69-9, 13162-05-5 and 88-12-0 and are available under the trade name Aristoflex® AVC from Clariant GmbH.

Hydrocolloids advantageous according to the invention are also so-called inverse emulsion thickeners, which are generally obtained by so-called emulsion polymerization of similar types and different types of water-soluble hydrophilic monomer units which are dispersed in a cosmetically acceptable hydrophobic medium, with the optional addition of stabilizers (generally surfactants). Examples thereof are, for example, Novemer ECI from Noveon, the raw material sold under the trade name Simulgel® A, Simulgel® EG, Simulgel® EPG, Simulgel® NS, Simulgel® 600 and Sepigel® 305, and Sepigel® 501 from Seppic S.A., or the Salcare SC91 and Salcare AST grades from Ciba.

Also advantageous are compounds which have the INCI name “Acrylates/C12-24 Pareth-25 Acrylate Copolymer” (available under the trade names Synthalen® W2000 from 3V Inc.), those which have the INCI name “Acrylates/Steareth-20 Methacrylate Copolymer” (available under the trade name Aculyn® 22 from the International Specialty Products Corp.), those which have the INCI name “Acrylates/Steareth-20 Itaconate Copolymer” (available under the trade names Structure 2001® from National Starch), those which have the INCI name “Acrylates/Aminoacrylates/C10-30 Alkyl PEG-20 Itaconate Copolymer” (available under the trade name Structure Plus® from National Starch) and similar polymers.

The hydrocolloids which are particularly preferred according to the invention are: Acrylates Copolymer (AQUA SF-1), Acrylates/C 10-30 Alkyl Acrylate Crosspolymer (Carbopol ETD 2020), Xanthan Gum (Kelter).

The inorganic hydrocolloid(s) can, for example, be advantageously chosen from the group of modified or unmodified, naturally occurring or synthetic sheet silicates.

Although it is entirely favourable to use pure components, it is, however, also possible in an advantageous manner, to use mixtures of different modified and/or unmodified sheet silicates.

Sheet silicates, which are also called phyllosilicates, are understood for the purposes of this application as meaning silicates and aluminosilicates in which the silicate or aluminate units, respectively, are joined together via three Si—O or Al—O bonds and form a waved sheet or layer structure. The fourth Si—O or Al—O valency can be saturated by cations. There are relatively weak electrostatic interactions, e.g. hydrogen bridge bonds, between the individual layers. The layer structure is consequently defined largely by strong covalent bonds.

The stoichiometry of the sheet silicates is
(Si₂O₅²⁻) for pure silicate structures and
(AlₘSi²⁻ₘO₅(^{2+m})⁻) for aluminosilicates.
m is a number greater than zero and less than 2.

If no pure silicates are present, but aluminosilicates, it should be taken into consideration that each Si⁴⁺ group replaced by Al³⁺ requires a further singly charged cation to neutralize the charge.

The charge is preferably balanced by H⁺, alkali metal or alkaline earth metal ions. Aluminium as counterion is also known and advantageous. In contrast to the aluminosilicates, these compounds are called aluminium silicates. “Aluminium aluminosilicates”, in which aluminium is present both in the silicate network, and also as counterion, are also known and in some cases advantageous for the present invention.

Sheet silicates are well documented in the literature, e.g. in the “Lehrbuch der Anorganischen Chemie” [Textbook of Inorganic Chemistry], A. F. Hollemann, E. Wiberg and N. Wiberg, 91st-100th edition, Walter de Gruyter-Verlag 1985, passim, and “Lehrbuch der Anorganischen Chemie” [Textbook of Inorganic Chemistry], H. Remy, 12th edition, Akademische Verlagsgesellschaft, Leipzig 1965, passim. The layer structure of montmorillonite can be found in Römpps Chemie-Lexikon, Franckh'sche Verlagshandlung W. Keller & Co., Stuttgart, 8th edition, 1985, p. 2668 f.

Examples of sheet silicates are:

| | |
|---|---|
| Montmorillonite | Na_{0.33}((Al_{1.67}Mg_{0.33})(OH)₂(Si₄O₁₀)) |
| often simplified to | Al₂O₃*4SiO₂*H₂O*nH₂O or Al₂[(OH)₂/ |
| | Si₄O₁₀].nH₂O |
| Kaolinite | Al₂(OH)₄(Si₂O₅) |
| Ilite | (K,H₃O)_{y}(Mg₃(OH)₂(Si_{4-y}Al_{y}O₁₀)) |
| and | (K,H₃O)_{y}(Al₂(OH)₂(Si_{4-y}Al_{y}O₁₀)) |
| | where y = 0.7-0.9 |
| Beidelite | (Ca,Na)_{0.3}(Al₂(OH)₂(Al_{0.5}Si_{3.5}O₁₀)) |
| Nontronite | Na_{0.33}(Fe₂(OH)₂(Al_{0.33}Si_{3.67}O₁₀)) |
| Saponite | (Ca,Na)_{0.33}((Mg,Fe)₃(OH)₂(Al_{0.33}Si_{3.67}O₁₀)) |
| Hectorite | Na_{0.33}((Mg,Li)₃(OH,F)₂(Si₄O₁₀)) |

Montmorillonite represents the main mineral of the naturally occurring bentonites.

Very advantageous inorganic hydrocolloids for the purposes of the present invention are aluminium silicates, such as the montmorillonites (bentonites, hectorites and derivatives thereof, such as quaternium-18 bentonite, quaternium-18 hectorite, stearalkonium bentonite and stearalkonium hectorite) and also magnesium aluminium silicates (Veegum® grades) and sodium magnesium silicates (Laponite® grades).

The chemical formula given above is only approximate since montmorillonites have a large capacity for ion exchange, Al can be replaced, for example, by Mg, Fe²⁺, Fe³⁺, Zn and others. The resulting negative charge of the octahedral layers is balanced by cations, in particular Na⁺ (sodium montmorillonite) and Ca²⁺ in interlayer positions.

Synthetic magnesium silicates and/or bentonites advantageous for the purposes of the present invention are sold, for example, by Süd-Chemie under the trade name Optigel®.

An aluminium silicate advantageous for the purposes of the present invention is sold, for example, by R.T. Vanderbilt Comp., Inc., under the trade name Veegum®. The various Veegum® grades, which are all advantageous according to the invention, are characterized by the following compositions

| | (regular | | | | |
|---|---|---|---|---|---|
| | grade) | HV | K | HS | S-728 |
| SiO₂ | 55.5 | 56.9 | 64.7 | 69.0 | 65.3 |
| MgO | 13.0 | 13.0 | 5.4 | 2.9 | 3.3 |
| Al₂O₃ | 8.9 | 10.3 | 14.8 | 14.7 | 17.0 |
| Fe₂O₃ | 1.0 | 0.8 | 1.5 | 1.8 | 0.7 |
| CaO | 2.0 | 2.0 | 1.1 | 1.3 | 1.3 |
| Na₂O | 2.1 | 2.8 | 2.2 | 2.2 | 3.8 |
| K₂O | 1.3 | 1.3 | 1.9 | 0.4 | 0.2 |

These products swell in water to form viscous gels, which have an alkaline reaction. The organophilization of montmorillonite or bentonites (exchange of the interlayer cations for quaternary alkyl ammonium ions) produces products which are referred to as bentones.

Bentone® is a trade name for various neutral and chemically inert gelling agents which are made up of long-chain, organic ammonium salts and specific types of montmorillonite. Bentones swell in organic media and cause these to swell. The gels are stable in dilute acids and alkalis, although upon prolonged contact with strong acids and alkalis they partially loose their gelling properties. Due to their organophilic character, the bentones are only sparingly wettable by water.

The following Bentone® grades are sold, for example, by Kronos Titan: Bentone® 27, an organically modified montmorillonite, Bentone® 34 (dimethyldioctylammonium bentonite), which is prepared in accordance with U.S. Pat. No. 2,531,427 and, because of its lipophilic groups, swells more readily in a lipophilic medium than in water, Bentone® 38, an organically modified montmorillonite, a cream-coloured to white powder, Bentone® LT, a purified clay mineral, Bentone® Gel MIO, an organically modified montmorillonite which is supplied as a very fine suspension in mineral oil (SUS-71) (10% bentonite, 86.7% mineral oil and 3.3% wetting agent), Bentone® Gel IPM, an organically modified bentonite which is suspended in isopropyl myristate (10% bentonite, 86.7% isopropyl myristate, 3.3% wetting agent), Bentone® Gel CAO, an organically modified montmorillonite which is taken up in castor oil (10% bentonite, 86.7% castor oil and 3.3% wetting agent), Bentone® Gel Lantrol, an organically modified montmorillonite which, in paste form, is intended for further processing, in particular for the preparation of cosmetic compositions; 10% bentonite, 64.9% lantrol (wool wax oil), 22.0% isopropyl myristate, 3.0% wetting agent and 0.1% propyl p-hydroxybenzoate, Bentone®Gel Lan I, a 10% strength Bentone®27 paste in a mixture of wool wax USP and isopropyl palmitate, Bentone® Gel Lan II, a bentonite paste in pure, liquid wool wax, Bentone® Gel NV, a 15% strength Bentone® 27 paste in dibutyl phthalate, Bentone® Gel OMS, a bentonite paste in Shellsol T., Bentone® Gel OMS 25, a bentonite paste in isoparaffinic hydrocarbons (Idopar® H), Bentone® Gel IPP, a bentonite paste in isopropyl palmitate.

It is advantageous for the purposes of the present invention if the content of the hydrocolloids according to the invention (one or more compounds) is chosen from the range from 0.05% by weight to 5% by weight, preferably from 0.1% by weight to 3% by weight, in each case based on the total weight of the cosmetic or dermatological preparation.

It is advantageous for the purposes of the present invention to use hydrocolloid mixtures from at least two different hydrocolloids. Particularly advantageous according to the invention are mixtures of:
xanthan gum and sheet silicates;
xanthan gum and polyacrylic acids;
sheet silicates and polyacrylic acids;
cellulose derivatives and polyacrylic acids;
cellulose derivatives and sheet silicates;
ammonium dimethyltauramide/vinylformamide copolymer and polyacrylate;
ammonium dimethyltauramide/vinylformamide copolymer and polyacrylamide;
xantham gum and polyacrylic acids and cellulose derivatives;
C10-30 alkyl acrylate crosspolymers and xanthan gum;
carbomer and xanthan gum; or
2 different carbomers.

Besides one or more oil phases, the preparations for the purposes of the present invention may preferably additionally comprise one or more water phases and be present, for example, in the form of O/W, W/O/W or O/W/O emulsions. Such formulations can preferably also be solids emulsions (i.e. emulsions which are stabilized by solids, e.g. Pickering emulsions), gel emulsions (gel emulsions or gel creams are sensorially particularly light products with a low content of emulsifiers, structurants or structure formers (e.g. fatty alcohols) and lipids), hydrodispersions or else gels, and foaming surfactant preparations.

Pickering/Solids-Stabilized Emulsions

Of particular advantage for the purposes of the present invention are also cosmetic or dermatological preparations which are stabilized only by very finely divided solids particles. Such “emulsifier-free” emulsions are also referred to as Pickering emulsions.

In Pickering emulsions, the solid material accumulates at the oil/water interface in the form of a layer, as a result of which coalescence of the disperse phases is prevented. Of essential importance here are, in particular, the surface properties of the solids particles, which should exhibit both hydrophilic and also lipophilic properties.

The stabilizing solids particles can also advantageously be surface-treated (“coated”) to repel water, the intention being to form or retain an amphiphilic character of these solids particles. The surface treatment can consist in providing the solids particles with a thin hydrophobic or hydrophilic coat by processes known per se.

The average particle diameter of the microfine solids particles used as stabilizer is preferably chosen to be less than 100 μm, particularly advantageously less than 50 μm. In this connection, it is essentially unimportant in what form (platelets, rods, spheres, etc.) or modification the solids particles used are present.

The microfine solids particles are preferably chosen from the group of amphiphilic metal oxide pigments. In particular,
titanium dioxides (coated and uncoated): e.g. Eusolex T-2000 from Merck, titanium dioxide MT-100 Z from Tayca Corporation
zinc oxides, e.g. Z-Cote and Z-Cote HP1 from BASF AG, MZ-300, MZ-500 and MZ-505M from Tayca Corporation
iron oxides
   are advantageous.

It is also advantageous if the microfine solids particles are chosen from the following group: boron nitrides, starch derivatives (tapioca starch, sodium corn starch octynyl succinate etc.), talc, latex particles.

It is advantageous according to the invention if the solids-stabilized emulsions comprise significantly less than 0.5% by weight of one or more emulsifiers or are even entirely emulsifier-free.

Also advantageous for the purposes of the present invention are, for example, formulations which comprise an emulsifier system which consists of
A. at least one emulsifier A chosen from the group of completely neutralized, partially neutralized or unneutralized branched and/or unbranched, saturated and/or unsaturated fatty acids with a chain length of from 10 to 40 carbon atoms,
B. at least one emulsifier B chosen from the group of polyethoxylated fatty acid esters with a chain length of from 10 to 40 carbon atoms and with a degree of ethoxylation of from 5 to 100 and
C. at least one coemulsifier C chosen from the group of saturated and/or unsaturated, branched and/or unbranched fatty alcohols with a chain length of from 10 to 40 carbon atoms.

The emulsifier or the emulsifiers A are preferably chosen from the group of fatty acids which are completely or partially neutralized with customary alkalis (such as, for example, sodium and/or potassium hydroxide, sodium and/or potassium carbonate, and mono- and/or triethanolamine). For example, stearic acid and stearates, isostearic acid and isostearates, palmitic acid and palmitates, and myristic acid and myristates are particularly advantageous.

The emulsifier or the emulsifiers B are preferably chosen from the following group: PEG-9 stearate, PEG-8 distearate, PEG-20 stearate, PEG-8 stearate, PEG-8 oleate, PEG-25 glyceryltrioleate, PEG-40 sorbitan lanolate, PEG-15 glyceryl ricinoleate, PEG-20 glyceryl stearate, PEG-20 glyceryl isostearate, PEG-20 glyceryl oleate, PEG-20 stearate, PEG-20 methyl glucose sesquistearate, PEG-30 glyceryl isostearate, PEG-20 glyceryl laurate, PEG-30 stearate, PEG-30 glyceryl stearate, PEG-40 stearate, PEG-30 glyceryl laurate, PEG-50 stearate, PEG-100 stearate, PEG-150 laurate. Polyethoxylated stearates, for example, are particularly advantageous.

The coemulsifier or the coemulsifiers C are preferably chosen according to the invention from the following group: behenyl alcohol (C₂₂H₄₅OH), cetearyl alcohol [a mixture of cetyl alcohol (C₁₆H₃₃OH) and stearyl alcohol (C₁₈H₃₇OH)], lanolin alcohols (wool wax alcohols, which are the unsaponifiable alcohol fraction of wool wax which is obtained following the saponification of wool wax). Particular preference is given to cetyl alcohol and cetylstearyl alcohol.

According to the invention, it is also advantageous to choose the weight ratios of emulsifier A to emulsifier B to coemulsifier C (A:B:C) as a:b:c, where a, b and c, independently of one another, may be rational numbers from 1 to 5, preferably from 1 to 3. Particular preference is given to a weight ratio of, for example, 1:1:1.

It is advantageous for the purposes of the present invention to choose the total amount of the emulsifiers A and B and of the coemulsifier C from the range from 2 to 20% by weight, advantageously from 5 to 15% by weight, in particular from 7 to 13% by weight, in each case based on the total weight of the formulation.

The cosmetic or dermatological formulations for the purposes of the present invention may have the customary composition and be used for cosmetic or dermatological light protection, and also for the treatment, care and cleansing of the skin, of the lips and of skin appendages (nails and/or hair) and as make-up product in decorative cosmetics.

As preparations of liquid or relatively solid consistency, they may be used as cosmetic cleansing lotions or cleansing creams which can be used, for example, to remove make-up or as mild washing and showering cream—if appropriate also for blemished skin. Such cleansing preparations may advantageously also be used as so-called rinse off preparations which are rinsed off following application to the skin.

The cosmetic and/or dermatological preparations according to the invention can also advantageously be in the form of a care product for the hair and/or the scalp, in particular a product for arranging the hair, which is used while blow-drying the hair, or a styling and treatment product.

Depending on their formulation, cosmetic or topical dermatological compositions for the purposes of the present invention can, for example, be used as skin protection cream, cleansing milk, day or night cream etc. It is in some cases possible and advantageous to use the compositions according to the invention as a base for pharmaceutical formulations.

For use, the cosmetic and dermatological preparations are applied to the skin and/or the hair in an adequate amount in the manner customary for cosmetics.

The cosmetic and dermatological preparations according to the invention can comprise cosmetic auxiliaries as are customarily used in such preparations, e.g. preservatives, preservative aids, complexing agents, bactericides, perfumes, substances for preventing foaming, dyes, pigments which have a colouring action, further thickeners, moisturizing and/or humectant substances, fillers which improve the feel on the skin, fats, oils, waxes or other customary constituents of a cosmetic or dermatological formulation, such as alcohols, polyols, polymers, foam stabilizers, electrolytes, organic solvents or silicone derivatives.

Advantageous preservatives for the purposes of the present invention are, for example, formaldehyde donors (such as, for example, DMDM hydantoin, which is available, for example, under the trade name Glydant™ from Lonza), mixtures containing iodopropyl butylcarbamate (e.g. those available under the trade names Glycacil-L, Glycacil-S from Lonza and/or Dekaben LMB from Jan Dekker), parabens (i.e. alkyl p-hydroxybenzoates, such as methyl-, ethyl-, propyl- and/or butylparaben), phenoxyethanol, ethanol, benzoic acid and the like. In addition, the preservative system according to the invention also usually advantageously comprises preservative aids, such as, for example, octoxyglycerol, glycine soya etc.

Advantageous complexing agents for the purposes of the present invention are, for example, EDTA, [S,S]-ethylenediamine disuccinate (EDDS), which is available, for example, under the trade name Octaquest from Octel, pentasodium ethylenediamine tetramethylenephosphonate, which is available, for example, under the trade name Dequest 2046 from Monsanto and/or iminodisuccinic acid, which is available, inter alia, from Bayer AG under the trade names Iminodisuccinate VP OC 370 (about 30% strength solution) and Baypure CX 100 solid.

Particularly advantageous preparations are also obtained when antioxidants are used as additives or active ingredients. According to the invention, the preparations advantageously comprise one or more antioxidants. Favourable, but nevertheless optional, antioxidants which may be used are all antioxidants customary or suitable for cosmetic and/or dermatological applications.

The antioxidant or the antioxidants are advantageously chosen from the group consisting of amino acids (e.g. glycine, histidine, tyrosine, tryptophan) and derivatives thereof, imidazoles (e.g. urocanic acid) and derivatives thereof, peptides, such as D,L-carnosine, D-carnosine, L-carnosine and derivatives thereof (e.g. anserine), carotenoids, carotenes (e.g. α-carotene, β-carotene, ψ-lycopene) and derivatives thereof, chlorogenic acid and derivatives thereof, lipoic acid and derivatives thereof (e.g. dihydrolipoic acid), aurothioglucose, propylthiouracil and other thiols (e.g. thioredoxin, glutathione, cysteine, cystine, cystamine and the glycosyl, N-acetyl, methyl, ethyl, propyl, amyl, butyl and lauryl, palmitoyl, oleyl, γ-linoleyl, cholesteryl and glyceryl esters thereof) and salts thereof, dilauryl thiodipropionate, distearyl thiodipropionate, thiodipropionic acid and derivatives thereof (esters, ethers, peptides, lipids, nucleotides, nucleosides and salts), and sulphoximine compounds (e.g. buthionine sulphoximines, homocysteine sulphoximine, buthionine sulphones, penta-, hexa-, heptathionine sulphoximine) in very low tolerated doses (e.g. pmol to μmol/kg), and also (metal) chelating agents (e.g. α-hydroxy fatty acids, palmitic acid, phytic acid, lactoferrin), α-hydroxy acids (e.g. citric acid, lactic acid, malic acid), humic acid, bile acid, bile extracts, bilirubin, biliverdin, EDTA, EGTA and derivatives thereof, unsaturated fatty acids and derivatives thereof (e.g. γ-linolenic acid, linoleic acid, oleic acid), folic acid and derivatives thereof, furfurylidenesorbitol and derivatives thereof, ubiquinone and ubiquinol and derivatives thereof, vitamin C and derivatives (e.g. ascorbyl palmitate, Mg ascorbyl phosphate, ascorbyl acetate), tocopherols and derivatives (e.g. vitamin E acetate), vitamin A and derivatives (vitamin A palmitate) and coniferyl benzoate of benzoin resin, rutinic acid and derivatives thereof, α-glycosylrutin, ferulic acid, furfurylideneglucitol, carnosine, butylhydroxytoluene, butylhydroxyanisol, nordihydroguaiacic acid, nordihydroguaiaretic acid, trihydroxybutyrophenone, uric acid and derivatives thereof, mannose and derivatives thereof, zinc and derivatives thereof (e.g. ZnO, ZnSO₄), selenium and derivatives thereof (e.g. selenomethionine), stilbenes and derivatives thereof (e.g. stilbene oxide, trans-stilbene oxide) and the derivatives (salts, esters, ethers, sugars, nucleotides, nucleosides, peptides and lipids) of these said active ingredients which are suitable according to the invention.

Preferred antioxidants are also vitamin E and derivatives thereof and vitamin A and derivatives thereof.

The amount of antioxidants (one or more compounds) in the preparations is preferably 0.001 to 30% by weight, particularly preferably 0.05 to 20% by weight, in particular 0.1 to 10% by weight, based on the total weight of the preparation.

If vitamin E and/or derivatives thereof are the antioxidant or the antioxidants, it is advantageous to choose their respective concentrations from the range from 0.001 to 10% by weight, based on the total weight of the formulation.

If vitamin A or vitamin A derivatives or carotenes or derivatives thereof are the antioxidant or the antioxidants, it is advantageous to choose their respective concentrations from the range from 0.001 to 10% by weight, based on the total weight of the formulation.

It is particularly advantageous when the cosmetic preparations according to the present invention comprise cosmetic or dermatological active ingredients, preferred active ingredients being antioxidants which can protect the skin against oxidative stress.

Further advantageous active ingredients for the purposes of the present invention are natural active ingredients and/or derivatives thereof, such as, for example, alpha-lipoic acid, phytoene, D-biotin, coenzyme Q10, alpha-glucosylrutin, carnitine, carnosine, natural and/or synthetic isoflavonoids, creatine, creatinine, taurine and/or β-alanine, and 8-hexadecene-1,16-dicarboxylic acid (dioic acid, CAS number 20701-68-2; provisional INCI name Octadecenedioic acid).

Formulations according to the invention which comprise, for example, known antiwrinkle active ingredients, such as flavone glycosides (in particular α-glucosylrutin), coenzyme Q10, vitamin A and/or derivatives, vitamin C and/or derivatives, vitamin E and/or derivatives and the like are particularly advantageously suitable for the prophylaxis and treatment of cosmetic or dermatological changes in the skin, as arise, for example, during skin ageing (such as, for example, dryness, roughness and formation of dryness wrinkles, itching, reduced refatting (e.g. after washing), visible vascular dilations (teleangiectasis, couperosis), flaccidity and formation of wrinkles and lines, local hyperpigmentation, hypopigmentation and incorrect pigmentation (e.g. age spots), increased susceptibility to mechanical stress (e.g. cracking) and the like). In addition, they are advantageously suitable to counter the appearance of dry or rough skin.

It is particularly advantageous for the purposes of the present invention when the active ingredients are present in encapsulated form such that they are physically separate from the formulation constituents (or further, non-compatible active ingredients). In this connection—depending on the nature of the active ingredient used—permanent encapsulations, i.e. capsules from which the active ingredients are not released into the cosmetic preparation or the skin (advantageously, for example, for UV filter substances) or non-permanent encapsulations are conceivable.

Advantageous encapsulations consist, for example, of plastics. It is further advantageous to encapsulate the further active ingredients into collagen matrices and other customary encapsulation materials, e.g. as cellulose encapsulations, in gelatin, wax matrices or liposomally encapsulated. In particular, wax matrices, as described in DE-A 43 08 282 have proven to be favourable. Particularly advantageous encapsulation forms for the purposes of the present invention are also cyclodextrin complexes of the other active ingredients.

Also advantageous are, for example, encapsulations which are obtainable by sol gel microtechnology. Here, the active ingredients are enclosed in an inert silica membrane, ultimately thus encapsulated in glass beads. For the purposes of the present invention, encapsulated active ingredients may advantageously also be used in the form of aqueous dispersions.

Encapsulated active ingredients are suitable in particular for the preparation of particularly skin compatible (sensitive) products. Moreover, it is of course advantageous to use active ingredients with potential skin irritancy in encapsulated form.

In addition, it is also advantageous for the purposes of the present invention to use active ingredient capsules referred to as “microbeads”. Advantageous “microbeads” are, for example, those listed below:

| Trade name | Manufacturer | Composition (INCl) |
|---|---|---|
| Unispheres | Induchem | Lactose + Cellulose + |
| UEL-611 | | Hydroxypropyl Methylcellulose + |
| | | Cl 77707 + Tocopherol Acetate |
| Unispheres | Induchem | Lactose + Cellulose + |
| RP-572 | | Hydroxypropyl Methylcellulose + |
| | | Panthenyl Triacetate + Cl 7360 |
| Unispheres | Induchem | Lactose + Cellulose + |
| UT-513 | | Hydroxypropyl Methylcellulose + |
| | | Cl 77707 + Tocopherol |
| Macrobeads | Wiblosan | Cetearyl Alcohol + Acrylates |
| | | Copolymer + Paraffinum |
| | | Liquidum + Microcrystalline |
| | | Cellulose + Bisabolol + |
| | | Tocopherol Acetate + Cl 74260 |

The water phase of the preparations according to the present invention can advantageously comprise customary cosmetic auxiliaries, such as, for example, alcohols, in particular those of low carbon number, preferably ethanol and/or isopropanol, diols or polyols of low carbon number, and ethers thereof, preferably propylene glycol, glycerol, butylene glycol, ethylene glycol, ethylene glycol monoethyl or monobutyl ether, propylene glycol monomethyl, monoethyl or monobutyl ether, diethylene glycol monomethyl or monoethyl ether and analogous products, foam stabilizers, electrolytes.

In addition, the preparations according to the invention can advantageously also comprise self-tanning substances, such as, for example, dihydroxyacetone and/or melanin derivatives in concentrations of from 1% by weight to 8% by weight, based on the total weight of the preparation.

In addition, the preparations according to the present invention can advantageously also comprise repellants for protection against flies, ticks and spiders and the like. For example, N,N-diethyl-3-methylbenzamide (trade name: Metadelphene, “DEET”), dimethyl phthalate (trade name; Palatinol M, DMP), and in particular ethyl 3-(N-n-butyl-N-acetylamino)propionate (available under the trade name Insekt Repellent® 3535 from Merck) are advantageous. The repellents can either be used individually or in combination.

Moisturizers is the term used to refer to substances or mixtures of substances which impart to cosmetic or dermatological preparations the property, following application or distribution on the surface of the skin, of reducing moisture release by the horny layer (also called transepidermal water loss (TEWL)) and/or of positively influencing hydration of the horny layer.

Advantageous moisturizers for the purposes of the present invention are, for example, glycerol, lactic acid and/or lactates, in particular sodium lactate, butylene glycol, propylene glycol, biosaccharide gum-1, glycine soya, ethylhexyloxyglycerol, pyrrolidonecarboxylic acid and uric acid. In addition, it is particularly advantageous to use polymeric moisturizers from the group of water-soluble and/or water-swellable and/or water-gellable polysaccharides. Hyaluronic acid, chitosan and/or a fucose-rich polysaccharide, which is filed in the Chemical Abstracts under the registry number 178463-23-5 and which is available, for example, under the name Fucogel® 1000 from SOLABIA S.A., for example, are particularly advantageous. Moisturizers can advantageously also be used as antiwrinkle active ingredients for the prophylaxis and treatment of cosmetic or dermatological changes in the skin, as arise, for example, during skin ageing.

The cosmetic or dermatological preparations according to the invention can also advantageously, but not necessarily, comprise fillers, which, for example, further improve the sensory and cosmetic properties of the formulations and, for example, bring about or enhance a velvety or silky feel on the skin. Advantageous fillers for the purposes of the present invention are pigments which have neither a primarily UV filter effect nor a colouring effect (such as, for example, boron nitride etc.) and/or Aerosils® (CAS No. 7631-86-9).

The oil phase of the formulations according to the invention is advantageously chosen from the group of polar oils, for example from the group of lecithins and of fatty acid triglycerides, namely the triglycerol esters of saturated and/or unsaturated, branched and/or unbranched alkanecarboxylic acids with a chain length of from 8 to 24, in particular 12 to 18, carbon atoms. The fatty acid triglycerides can, for example, be chosen advantageously from the group of synthetic or semisynthetic and natural oils, such as, for example, cocoglyceride, olive oil, sunflower oil, soya oil, peanut oil, rapeseed oil, almond oil, palm oil, coconut oil, castor oil, wheatgerm oil, grapeseed oil, thistle oil, evening primrose oil, macadamia nut oil and the like.

Also advantageous according to the invention are, for example, natural waxes of animal and vegetable origin, such as, for example, beeswax and other insect waxes, and berry wax, shea butter and/or lanolin (wool wax).

For the purposes of the present invention, further advantageous polar oil components can also be chosen from the group of esters of saturated and/or unsaturated, branched and/or unbranched alkanecarboxylic acids with a chain length of from 3 to 30 carbon atoms and saturated and/or unsaturated, branched and/or unbranched alcohols with a chain length of from 3 to 30 carbon atoms, and from the group of esters of aromatic carboxylic acids and saturated and/or unsaturated, branched and/or unbranched alcohols with a chain length of from 3 to 30 carbon atoms. Such ester oils can then advantageously be chosen from the group consisting of octyl palmitate, octyl cocoate, octyl isostearate, octyl dodecyl myristate, octyldodecanol, cetearyl isononanoate, isopropyl myristate, isopropyl palmitate, isopropyl stearate, isopropyl oleate, n-butyl stearate, n-hexyl laurate, n-decyl oleate, isooctyl stearate, isononyl stearate, isononyl isononanoate, 2-ethylhexyl palmitate, 2-ethylhexyl laurate, 2-hexyldecyl stearate, 2-octyldodecyl palmitate, stearyl heptanoate, oleyl oleate, oleyl erucate, erucyl oleate, erucyl erucate, tridecyl stearate, tridecyl trimellitate, and synthetic, semisynthetic and natural mixtures of such esters, such as, for example, jojoba oil.

The oil phase can also advantageously be chosen from the group of dialkyl ethers and dialkyl carbonates, advantageous examples being dicaprylyl ether (Cetiol OE) and/or dicaprylyl carbonate, for example that available under the trade name Cetiol CC from Cognis.

It is also preferred to select the oil component or the oil components from the group consisting of isoeicosane, neopentyl glycol diheptanoate, propylene glycol dicaprylate/dicaprate, caprylic/capric/diglyceryl succinate, butylene glycol dicaprylate/dicaprate, C₁₂₋₁₃-alkyl lactate, di-C₁₂₋₁₃-alkyl tartrate, triisostearin, dipentaerythrityl hexacaprylate/hexacaprate, propylene glycol monoisostearate, tricaprylin, dimethylisosorbide. It is particularly advantageous if the oil phase of the formulations according to the invention has a content of C₁₂₋₁₅-alkyl benzoate, or consists entirely of this.

Advantageous oil components are also, for example, butyloctyl salicylate (for example that available under the trade name Hallbrite BHB from CP Hall), hexadecyl benzoate and butyloctyl benzoate and mixtures thereof (Hallstar AB) and/or diethylhexyl naphthalate (Hallbrite TQ or Corapan TQ from H&R).

Any desired mixtures of such oil and wax components can also be used advantageously for the purposes of the present invention.

In addition, the oil phase can likewise advantageously also comprise non-polar oils, for example those which are chosen from the group of branched and unbranched hydrocarbons and hydrocarbon waxes, in particular mineral oil, vaseline (petrolatum), paraffin oil, squalane and squalene, polyolefins, hydrogenated polyisobutenes and isohexadecane. Among the polyolefins, polydecenes are the preferred substances.

The oil phase can also advantageously have a content of cyclic or linear silicone oils or consist entirely of such oils, although it is preferred to use an additional content of other oil phase components apart from the silicone oil or the silicone oils.

Silicone oils are high molecular weight synthetic polymeric compounds in which silicon atoms are joined in a chain-like and/or reticular manner via oxygen atoms and the remaining valences of the silicon are saturated by hydrocarbon radicals (in most cases methyl, less often ethyl, propyl, phenyl groups etc.). Systematically, the silicone oils are referred to as polyorganosiloxanes. The methyl-substituted polyorganosiloxanes, which are the most important compounds of this group in terms of amount and are characterized by the following structural formula 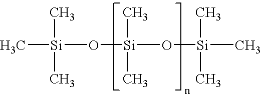
are also referred to as polydimethylsiloxane or Dimethicone (INCI). Dimethicones have various chain lengths and various molecular weights.

Particularly advantageous polyorganosiloxanes for the purposes of the present invention are, for example, dimethylpolysiloxanes [poly(dimethylsiloxane)], which are available, for example, under the trade names Abil 10 to 10 000 from Th. Goldschmidt. Also advantageous are phenylmethylpolysiloxanes (INCI: Phenyl Dimethicone, Phenyl Trimethicone), cyclic silicones (octamethylcyclotetrasiloxane and decamethylcyclopentasiloxane), which are also referred to in accordance with INCI as Cyclomethicone, amino-modified silicones (INCI: Amodimethicone) and silicone waxes, e.g. polysiloxane-polyalkylene copolymers (INCI: Stearyl Dimethicone and Cetyl Dimethicone) and dialkoxydimethylpolysiloxanes (Stearoxy Dimethicone and Behenoxy Stearyl Dimethicone), which are available as various Abil wax grades from Th. Goldschmidt. However, other silicone oils can also be used advantageously for the purposes of the present invention, for example cetyidimethicone, hexamethylcyclotrisiloxane, polydimethylsiloxane, poly(methylphenylsiloxane).

The preparations according to the present invention can also advantageously comprise one or more substances from the following group of siloxane elastomers, for example in order to increase the water resistance and/or the light protection factor of the products:
(a) siloxane elastomers which contain the units R₂SiO and RSiO_{1.5} and/or R₃SiO_{0.5} and/or SiO₂,
   where the individual radicals R, in each case independently of one another, are hydrogen, C₁₋₂₄-alkyl (such as, for example, methyl, ethyl, propyl) or aryl (such as, for example, phenyl or tolyl), alkenyl (such as, for example, vinyl), and the weight ratio of the units R₂SiO to RSiO_{1.5} is chosen from the range from 1:1 to 30:1;
(b) siloxane elastomers which are insoluble and swellable in silicone oil and which are obtainable by the addition reaction of an organopolysiloxane (1) which contains silicon-bonded hydrogen with an organopolysiloxane (2) which contains unsaturated aliphatic groups,
   where the quantitative amounts used are chosen such that the amount of hydrogen in the organopolysiloxane (1) or in the unsaturated aliphatic groups of the organopolysiloxane (2)
      is in the range from 1 to 20 mol % when the organopolysiloxane is non-cyclic and
      is in the range from 1 to 50 mol % when the organopolysiloxane is cyclic.

For the purposes of the present invention, the siloxane elastomer or elastomers are advantageously present in the form of spherical powders or in the form of gels.

Siloxane elastomers present in the form of spherical powders which are advantageous according to the invention are those with the INCI name Dimethicone/Vinyl Dimethicone Crosspolymer, for example that available from DOW CORNING under the trade names DOW CORNING 9506 Powder.

It is particularly preferred when the siloxane elastomer is used in combination with oils from hydrocarbons of animal and/or vegetable origin, synthetic oils, synthetic esters, synthetic ethers or mixtures thereof.

It is very particularly preferred when the siloxane elastomer is used in combination with unbranched silicone oils which are liquid or pasty at room temperature or cyclic silicone oils or mixtures thereof. Organopolysiloxane elastomers with the INCI name Dimethicone/Polysilicone-11, very particularly the Gransil grades obtainable from Grant Industries Inc. GCM, GCM-5, DMG-6, CSE gel, PM-gel, LTX, ININ gel, AM-18 gel and/or DMCM-5, are particularly advantageous.

It is very extremely preferred when the siloxane elastomer is used in the form of a gel of siloxane elastomer and a lipid phase where the content of the siloxane elastomer in the gel is 1 to 80% by weight, preferably 0.1 to 60% by weight, in each case based on the total weight of the gel.

It is advantageous for the purposes of the present invention to choose the total amount of the siloxane elastomers (active content) from the range from 0.01 to 10% by weight, advantageously from 0.1 to 5% by weight, in each case based on the total weight of the formulation.

The cosmetic and dermatological preparations according to the invention can comprise dyes and/or colour pigments, particularly when they are in the form of decorative cosmetics. The dyes and color pigments can be chosen from the corresponding positive list in the Cosmetics Directive or the EC list of cosmetic colorants. In most cases, they are identical to dyes approved for foods. Advantageous colour pigments are, for example, titanium dioxide, mica, iron oxides (e.g. Fe₂O₃, Fe₃O₄, FeO(OH)) and/or tin oxide. Advantageous dyes are, for example, carmine, Prussian blue, chromium oxide green, ultramarine blue and/or manganese violet. It is particularly advantageous to choose the dyes and/or the colour pigments from the Rowe Colour Index, 3rd Edition, Society of Dyers and Colourists, Bradford, England, 1971.

If the formulations according to the invention are in the form of products which are used on the face, it is favourable to choose one or more substances from the following group as the dye: 2,4-dihydroxyazobenzene, 1-(2′-chloro-4′-nitro-1′-phenylazo)-2-hydroxynaphthalene, Ceres red, 2-(sulpho-1-naphthylazo)-1-naphthol-4-sulphonic acid, calcium salt of 2-hydroxy-1,2′-azonaphthalene-1′-sulphonic acid, calcium and barium salts of 1-(2-sulpho-4-methyl-1-phenylazo)-2-naphthylcarboxylic acid, calcium salt of 1-(2-sulpho-1-naphthylazo)-2-hydroxynaphthalene-3-carboxylic acid, aluminium salt of 1-(4-sulpho-1-phenylazo)-2-naphthol-6-sulphonic acid, aluminium salt of 1-(4-sulpho-1-naphthylazo)-2-naphthol-3,6-disulphonic acid, 1-(4-sulpho-1-naphthylazo)-2-naphthol-6,8-disulphonic acid, aluminium salt of 4-(4-sulpho-1-phenylazo)-1-(4-sulphophenyl)-5-hydroxypyrazolone-3-carboxylic acid, aluminium and zirconium salts of 4,5-dibromofluorescein, aluminium and zirconium salts of 2,4,5,7-tetrabromofluorescein, 3′,4′,5′,6′-tetrachloro-2,4,5,7-tetrabromofluorescein and its aluminium salt, aluminium salt of 2,4,5,7-tetraiodofluorescein, aluminium salt of quinophthalonedisulphonic acid, aluminium salt of indigodisulphonic acid, red and black iron oxide (CIN: 77 491 (red) and 77 499 (black)), iron oxide hydrate (CIN: 77 492), manganese ammonium diphosphate and titanium dioxide.

Also advantageous are oil-soluble natural dyes, such as, for example, paprika extracts, β-carotene or cochineal.

Also advantageous for the purposes of the present invention are formulations with a content of pearlescent pigments. Preference is given in particular to the types of pearlescent pigments listed below:
1. Natural pearlescent pigments, such as, for example,
   “pearl essence” (guanine/hypoxanthin mixed crystals from fish scales) and
   “mother-of-pearl” (ground mussel shells)
2. Monocrystalline pearlescent pigments, such as, for example, bismuth oxychloride (BiOCl)
3. Layer-substrate pigments: e.g. mica/metal oxide

Bases for pearlescent pigments are, for example, pulverulent pigments or castor oil dispersions of bismuth oxychloride and/or titanium dioxide, and bismuth oxychloride and/or titanium dioxide on mica. The lustre pigment listed under CIN 77163, for example, is particularly advantageous.

Also advantageous are, for example, the following types of pearlescent pigments based on mica/metal oxide:

| Group | Coating/layer thickness | Colour |
|---|---|---|
| Silver-white pearlescent | TiO₂: 40-60 nm | Silver |
| pigments | | |
| Interference pigments | TiO₂: 60-80 nm | Yellow |
| | TiO₂: 80-100 nm | Red |
| | TiO₂: 100-140 nm | Blue |
| | TiO₂: 120-160 nm | Green |
| Colour lustre pigments | Fe₂O₃ | Bronze |
| | Fe₂O₃ | Copper |
| | Fe₂O₃ | Red |
| | Fe₂O₃ | Red-violet |
| | Fe₂O₃ | Red-green |
| | Fe₂O₃ | Black |
| Combination pigments | TiO₂/Fe₂O₃ | Gold shades |
| | TiO₂/Cr₂O₃ | Green |
| | TiO₂/Prussian blue | Deep blue |
| | TiO₂/carmine | Red |

Particular preference is given, for example, to the pearlescent pigments obtainable from Merck under the trade names Timiron, Colorona or Dichrona.

The list of given pearlescent pigments is not of course intended to be limiting. Pearlescent pigments which are advantageous for the purposes of the present invention are obtainable by numerous methods known per se. For example, other substrates apart from mica can be coated with further metal oxides, such as, for example, silica and the like. SiO₂ particles coated with, for example, TiO₂ and Fe₂O₃ (“ronaspheres”), which are sold by Merck and are particularly suitable for the optical reduction of fine lines, are advantageous.

It can, moreover, be advantageous to dispense completely with a substrate such as mica. Particular preference is given to iron pearlescent pigments prepared without the use of mica. Such pigments are obtainable, for example, under the trade name Sicopearl Kupfer 1000 from BASF.

In addition, also particularly advantageous are effect pigments which are obtainable under the trade name Metasomes Standard/Glitter in various colours (yellow, red, green, blue) from Flora Tech. The glitter particles are present here in mixtures with various auxiliaries and dyes (such as, for example, the dyes with the Colour Index (CI) numbers 19140, 77007, 77289, 77491).

The dyes and pigments may be present either individually or in a mixture, and can be mutually coated with one another, different coating thicknesses generally giving rise to different colour effects. The total amount of dyes and colour-imparting pigments is advantageously chosen from the range from, for example, 0.1% by weight to 30% by weight, preferably from 0.5 to 15% by weight, in particular from 1.0 to 10% by weight, in each case based on the total weight of the preparations.

For the purposes of the present invention, it is also advantageous to provide cosmetic and dermatological preparations whose main purpose is not protection against sunlight, but which nevertheless have a content of further UV protection substances. Thus, for example, UV-A and/or UV-B filter substances are usually incorporated into daycreams or make-up products. UV protection substances, like antioxidants and, if desired, preservatives, also constitute effective protection of the preparations themselves against spoilage. Also favourable are cosmetic and dermatological preparations in the form of a sunscreen.

Accordingly, for the purposes of the present invention, the preparations preferably comprise at least one further UV-A, UV-B and/or broadband filter substance. The formulations can, but do not necessarily, optionally also comprise one or more organic and/or inorganic pigments as UV filter substances, which may be present in the water phase and/or the oil phase.

In addition, the preparations according to the present invention can also advantageously be in the form of so-called oil-free cosmetic or dermatological emulsions, which comprise a water phase and at least one UV filter substance which is liquid at room temperature as a further phase, and which may particularly advantageously also be free from further oil components.

For the purposes of the present invention, particularly advantageous UV filter substances which are liquid at room temperature are homomenthyl salicylate (INCI: Homosalate), 2-ethylhexyl 2-cyano-3,3-diphenylacrylate (INCI: Octocrylene), 2-ethylhexyl 2-hydroxybenzoate (2-ethylhexyl salicylate, octyl salicylate, INCI: Ethylhexyl Salicylate) and esters of cinnamic acid, preferably 2-ethylhexyl 4-methoxycinnamate (INCI: Ethylhexyl Methoxycinnamate) and isopentyl 4-methoxycinnamate (INCI: Isoamyl p-Methoxycinnamate), 3-(4-(2,2-bis-ethoxycarbonylvinyl)phenoxy)propenyl)methoxysiloxane/dimethylsiloxane copolymer, which is available, for example, under the trade name Parsol® SLX from Hoffmann La Roche.

Preferred inorganic pigments are metal oxides and/or other metal compounds which are insoluble or sparingly soluble in water, in particular oxides of titanium (TiO₂), zinc (ZnO), iron (e.g. Fe₂O₃), zirconium (ZrO₂), silicon (SiO₂), manganese (e.g. MnO), aluminium (Al₂O₃), cerium (e.g. Ce₂O₃), mixed oxides of the corresponding metals, and mixtures of such oxides, and also the sulphate of barium (BaSO₄).

For the purposes of the present invention, the pigments may advantageously also be used in the form of commercially available oily or aqueous predispersions. Dispersion auxiliaries and/or solubility promoters may advantageously be added to these predispersions.

According to the invention, the pigments may advantageously be surface-treated (“coated”), the intention being to form or retain, for example, a hydrophilic, amphiphilic or hydrophobic character. This surface treatment can consist in providing the pigments with a thin hydrophilic and/or hydrophobic inorganic and/or organic coat by methods known per se. For the purposes of the present invention, the various surface coatings may also comprise water.

Inorganic surface coatings for the purposes of the present invention may consist of aluminium oxide (Al₂O₃), aluminium hydroxide Al(OH)₃, or aluminium oxide hydrate (also: alumina, CAS No.: 1333-84-2), sodium hexametaphosphate (NaPO₃)₆, sodium metaphosphate (NaPO₃)ₙ, silicon dioxide (SiO₂) (also: silica, CAS No.: 7631-86-9), or iron oxide (Fe₂O₃). These inorganic surface coatings may be present on their own, in combination and/or in combination with organic coating materials.

Organic surface coatings for the purposes of the present invention may consist of vegetable or animal aluminium stearate, vegetable or animal stearic acid, lauric acid, dimethylpolysiloxane (also: Dimethicone), methylpolysiloxane (Methicone), simethicone (a mixture of dimethylpolysiloxane with an average chain length of from 200 to 350 dimethylsiloxane units and silica gel) or alginic acid. These organic surface coatings may be present on their own, in combination and/or in combination with inorganic coating materials.

Zinc oxide particles and predispersions of zinc oxide particles which are suitable according to the invention are obtainable under the following trade names from the companies listed:

| Trade name | Coating | Manufacturer |
|---|---|---|
| Z-Cote HP1 | 2% Dimethicone | BASF |
| Z-Cote | / | BASF |
| ZnO NDM | 5% Dimethicone | H&R |
| MZ-303S | 3% Methicone | Tayca Corporation |
| MZ-505S | 5% Methicone | Tayca Corporation |

Suitable titanium dioxide particles and predispersions of titanium dioxide particles are available under the following trade names from the companies listed:

| Trade name | Coating | Manufacturer |
|---|---|---|
| MT-100TV | Aluminium hydroxide/ | Tayca Corporation |
| | stearic acid | |
| MT-100Z | Aluminium hydroxide/ | Tayca Corporation |
| | stearic acid | |
| Eusolex T-2000 | Alumina/Simethicone | Merck KgaA |
| Titanium dioxide | Octyltrimethylsilane | Degussa |
| T805 | | |
| (Uvinul TiO₂) | | |
| Tioveil AQ 10PG | Alumina/Silica | Solaveil/Uniquema |
| Eusolex T-aqua | Water/alumina/sodium | Merck |
| | metaphosphate | |

Further advantageous pigments are latex particles. Latex particles advantageous according to the invention are those described in the following specifications: U.S. Pat. No. 5,663,213 and EP 0 761 201. Particularly advantageous latex particles are those which are formed from water and styrene/acrylate copolymers and are available, for example, under the trade name “Alliance SunSphere” from Rohm & Haas.

Advantageous UV-A filter substances for the purposes of the present invention are dibenzoylmethane derivatives, in particular 4-(tert-butyl)-4′-methoxydibenzoylmethane (CAS No. 70356-09-1), which is sold by Givaudan under the name Parsol® 1789 and by Merck under the trade name Eusolex® 9020.

Advantageous further UV filter substances for the purposes of the present invention are sulphonated, water-soluble UV filters, such as, for example:
phenylene-1,4-bis(2-benzimidazyl)-3,3′-5,5′-tetrasulphonic acid and its salts, particularly the corresponding sodium, potassium or triethanolammonium salts, in particular the phenylene-1,4-bis(2-benzimidazyl)-3,3′-5,5′-tetrasulphonic acid bis-sodium salt with the INCI name Disodium Phenyl Dibenzimidazole Tetrasulfonate (CAS No.: 180898-37-7), which is available, for example, under the trade name Neo Heliopan AP from Haarmann & Reimer;
salts of 2-phenylbenzimidazole-5-sulphonic acid, such as its sodium, potassium or its triethanolammonium salt, and the sulphonic acid itself with the INCI name Phenylbenzimidazole Sulfonic Acid (CAS No. 27503-81-7), which is available, for example, under the trade name Eusolex 232 from Merck, or under Neo Heliopan Hydro from Haarmann & Reimer;
1,4-di(2-oxo-10-sulpho-3-bornylidenemethyl)benzene (also: 3,3′-(1,4-phenylene-dimethylene)bis(7,7-dimethyl-2-oxobicyclo[2.2.1]hept-1-ylmethanesulphonic acid) and salts thereof (particularly the corresponding 10-sulphato compounds, in particular the corresponding sodium, potassium or triethanolammonium salt), which is also referred to as benzene-1,4-di(2-oxo-3-bornylidenemethyl-10-sulphonic acid). Benzene-1,4-di(2-oxo-3-bornylidenemethyl-10-sulphonic acid) has the INCI name Terephthalidene Dicamphor Sulfonic Acid (CAS No.: 90457-82-2) and is available, for example, under the trade name Mexoryl SX from Chimex;
sulphonic acid derivatives of 3-benzylidenecamphor, such as, for example, 4-(2-oxo-3-bornylidenemethyl)benzenesulphonic acid, 2-methyl-5-(2-oxo-3-bornylidenemethyl)sulphonic acid and salts thereof.

Further advantageous UV filter substances for the purposes of the present invention are benzoxazole derivatives which are characterized by the following structural formula, 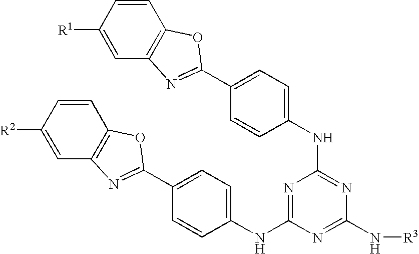
in which R¹, R² and R³, independently of one another, are chosen from the group of branched or unbranched, saturated or unsaturated alkyl radicals having 1 to 10 carbon atoms. It is particularly advantageous according to the invention to choose the radicals R¹ and R² to be the same, in particular from the group of branched alkyl radicals having 3 to 5 carbon atoms. It is also particularly advantageous for the purposes of the present invention if R³ is an unbranched or branched alkyl radical having 8 carbon atoms, in particular the 2-ethylhexyl radical.

A benzoxazole derivative which is particularly preferred according to the invention is 2,4-bis[5-1 (dimethylpropyl)benzoxazol-2-yl(4-phenyl)imino]-6-(2-ethylhexyl)imino-1,3,5-triazine with the CAS No. 288254-16-0, which is characterized by the structural formula 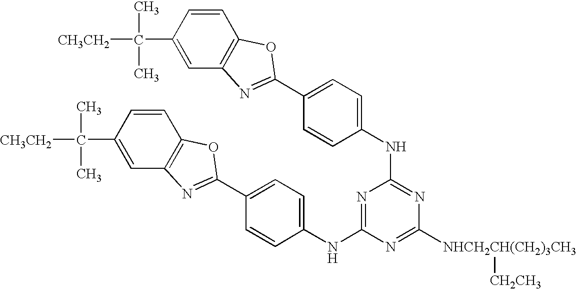
and is available from 3V Sigma under the trade name Uvasorb® K2A.

The benzoxazole derivative or derivatives are advantageously present in the cosmetic preparations according to the invention in dissolved form. In some circumstances, however, it may also be advantageous if the benzoxazole derivative or derivatives are present in pigmentary, i.e. undissolved, form—for example in particle sizes of from 10 nm to 300 nm.

Further advantageous UV filter substances for the purposes of the present invention are so-called hydroxybenzophenones. Hydroxybenzophenones are characterized by the following structural formula: 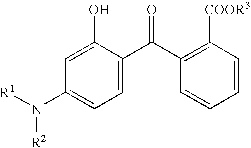
in which
R¹ and R², independently of one another, are hydrogen, C₁-C₂₀-alkyl, C₃-C₁₀-cycloalkyl or C₃-C₁₀-cycloalkenyl, where the substituents R¹ and R², together with the nitrogen atom to which they are bonded, can form a 5-membered or 6-membered ring and
R³ is a C₁-C₂₀-alkyl radical.

A particularly advantageous hydroxybenzophenone for the purposes of the present invention is hexyl 2-(4′-diethylamino-2′-hydroxybenzoyl)benzoate (also: Aminobenzophenone), which is characterized by the following structure: 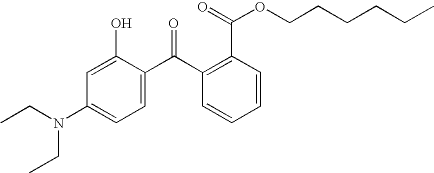
and is available under Uvinul A Plus from BASF.

Advantageous UV filter substances for the purposes of the present invention are also so-called broadband filters, i.e. filter substances which absorb both UV-A and also UV-B radiation.

Advantageous broadband filters or UV-B filter substances are, for example, triazine derivatives, such as, for example,
2,4-bis{[4-(2-ethylhexyloxy)-2-hydroxy]phenyl}-6-(4-methoxyphenyl)-1,3,5-triazine (INCI: Bis-Ethylhexyloxyphenol Methoxyphenyl Triazine), which is available under the trade name Tinosorb® S from CIBA-Chemikalien GmbH;
dioctylbutylamidotriazone (INCI: Diethylhexyl Butamido Triazone), which is available under the trade name UVASORB HEB from Sigma 3V;
Tris(2-ethylhexyl) 4,4′,4″-(1,3,5-triazine-2,4,6-triyltriimino)trisbenzoate, also: 2,4,6-tris[anilino(p-carbo-2′-ethyl-1′-hexyloxy)]-1,3,5-triazine (INCI: Ethylhexyl Triazone), which is sold by BASF Aktiengesellschaft under the trade name UVINUL® T 150; 2-[4,6-bis(2,4-dimethylphenyl)-1,3,5-triazin-2-yl]-5-(octyloxy)phenol (CAS No.: 2725-22-6).

An advantageous broadband filter for the purposes of the present invention is also 2,2′-methylenebis(6-(2H-benzotriazol-2-yl)-4-(1,1,3,3-tetramethylbutyl)phenol), (INCI: Methylene Bis-Benztriazolyl Tetramethylbutylphenol) which is available, for example, under the trade name Tinosorb® M from CIBA-Chemikalien GmbH.

For the purposes of the present invention, an advantageous broadband filter is also 2-(2H-benzotriazol-2-yl)-4-methyl-6-[2-methyl-3-[1,3,3,3-tetramethyl-1-[(trimethylsilyl)oxy]disiloxanyl]propyl]phenol (CAS No.: 155633-54-8) with the INCI name Drometrizole Trisiloxane.

The further UV filter substances may be oil-soluble or water-soluble. Advantageous oil-soluble filter substances are, for example:
3-benzylidenecamphor derivatives, preferably 3-(4-methylbenzylidene)camphor, 3-benzylidenecamphor;
4-aminobenzoic acid derivatives, preferably 2-ethylhexyl 4-(dimethyl-amino)benzoate, amyl 4-(dimethylamino)benzoate;
2,4,6-trianilino(p-carbo-2′-ethyl-1′-hexyloxy)-1,3,5-triazine;
esters of benzalmalonic acid, preferably di(2-ethylhexyl) 4-methoxybenzal-malonate;
esters of cinnamic acid, preferably 2-ethylhexyl 4-methoxycinnamate, isopentyl 4-methoxycinnamate;
derivatives of benzophenone, preferably 2-hydroxy-4-methoxybenzophenone, 2-hydroxy-4-methoxy-4′-methylbenzophenone, 2,2′-dihydroxy-4-methoxy-benzophenone and
UV filters bonded to polymers.

Advantageous water-soluble filter substances are, for example: Sulphonic acid derivatives of 3-benzylidenecamphor, such as, for example, 4-(2-oxo-3-bornylidenemethyl)benzenesulphonic acid, 2-methyl-5-(2-oxo-3-bornylidene-methyl)sulphonic acid and salts thereof.

A further light protection filter substance to be used advantageously according to the invention is ethylhexyl 2-cyano-3,3-diphenylacrylate (octocrylene), which is available from BASF under the name Uvinul® N 539 T.

Besides the filter substance(s) according to the invention, particularly advantageous preparations for the purposes of the present invention which are characterized by high or very high UV-A protection preferably also comprise further UV-A and/or broadband filters, in particular dibenzoylmethane derivatives [for example 4-(tert-butyl)-4′-methoxydibenzoylmethane] and/or 2,4-bis{[4-(2-ethyl-hexyloxy)-2-hydroxy]phenyl}-6-(4-methoxyphenyl)-1,3,5-triazine and/or phenylene-1,4-bis(2-benzimidazyl)-3,3′-5,5′-tetrasulphonic acid bis-sodium salt, in each case individually or in any combinations with one another.

The list of given UV filters which can be used for the purposes of the present invention is not of course intended to be limiting.

The preparations according to the invention advantageously comprise the substances which absorb UV radiation in the UV-A and/or UV-B region in a total amount of, for example, from 0.1% by weight to 30% by weight, preferably from 0.5 to 20% by weight, in particular 1.0 to 15.0% by weight, in each case based on the total weight of the preparations, in order to provide cosmetic preparations which protect the hair and/or the skin from the entire range of ultraviolet radiation.

The preparations for the purposes of the present invention can also advantageously comprise further substances which increase the water resistance of the products, in particular when these are to be used as sunscreen products.

For the purposes of the present invention, it is advantageous to use PEG-45 dodecyl glycol copolymer (INCI: PEG-45 Dodecyl Glycol Copolymer [y=z=11 and x=45]) and PEG-22 dodecyl glycol copolymer (INCI: PEG-22 Dodecyl Glycol Copolymer [y=z=4.5 and x=22]) and methoxy PEG-22 dodecyl glycol copolymer (INCI: Methoxy PEG-22 Dodecyl Glycol Copolymer [y=7 and x=22 and R=CH₃]), which are available from AKZO Nobel.

For example, water-soluble or water-dispersible polyoxyethylene-polyoxypropylene block polymers (CTFA name: Polaxamers, CAS No. 9003-11-6) with the following structure are also advantageous: 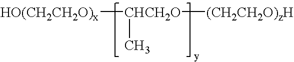
where x, y and z are integers from the range from 2 to 130, in particular from 15 to 100, and x and z are identical, but are chosen independently of y.

Of these, Polaxamer 188 [where x=75, y=30 and z=75), which can be obtained under the trade name Lutrol F 68 (formerly: Pluronic F 68) from BASF, Polaxamer 185 [where x=19, y=30 and z=19] (Lubrajel WA from ISP), Polaxamer 235 [where x=27, y=39 and z=27] (Pluronic F 85 from BASF) and/or Polaxamer 238 [where x=97, y=39 and z=97] (Pluronic F 88 from BASF) are to be used particularly advantageously.

Further advantageous substances which can contribute to the increase in the water resistance, but are incorporated in the oil phase of the preparations according to the present invention, are certain wax components, such as acetylated glycol stearate with tristearin (e.g. Unitwix from ISP with the INCI: Acetylated Glycol Stearate and Tristearin), C₁₃₆ fatty acid triglyceride (e.g.: Syncrowax HGLC from Crode GmbH with the INCI: C18-36 Acid Triglyceride), and the substances obtainable under the trade names “Performa V 1608” (INCI: C30-38 Olefin/Isopropyl Maleate/MA Copolymer) and “Performa V 825” (synthetic wax) from New Phase Technologies.

It is particularly advantageous for the purposes of the present invention to combine the substances mentioned with one another in order to further improve the water resistance of the preparations.

In addition, the preparations according to the present invention can advantageously also comprise surfactants, particularly when they are in the form of foaming surfactant preparations.

Surfactants are amphiphilic substances which can dissolve organic, non-polar substances in water. As a result of their specific molecular structure having at least one hydrophilic molecular moiety and one hydrophobic molecular moiety, they are able to reduce the surface tension of the water, wet the skin, facilitate the removal and dissolution of soiling, facilitate rinsing and, if desired, control foaming.

The hydrophilic moieties of a surfactant molecule are mostly polar functional groups, for example —COO⁻, —OSO₃²⁻, —SO₃⁻, while the hydrophobic moieties are usually non-polar hydrocarbon radicals. Surfactants are generally classified according to the type and charge of the hydrophilic molecular moiety. In this connection, it is possible to differentiate between four groups:
anionic surfactants,
cationic surfactants,
amphoteric surfactants and
nonionic surfactants.

Anionic surfactants usually have, as functional groups, carboxylate, sulphate or sulphonate groups. In aqueous solution, they form negatively charged organic ions in an acidic or neutral medium. Cationic surfactants are characterized almost exclusively by the presence of a quaternary ammonium group. In aqueous solution, they form positively charged organic ions in an acidic or neutral medium. Amphoteric surfactants contain both anionic and cationic groups and accordingly in aqueous solution exhibit the behaviour of anionic or cationic surfactants depending on the pH. In a strongly acidic medium, they have a positive charge, and in an alkaline medium a negative charge. By contrast, in the neutral pH range, they are zwitterionic, as the example below aims to illustrate:

| | |
|---|---|
| RNH₂⁺CH₂CH₂COOH X⁻ | (at pH = 2) X⁻ = any anion, e.g. Cl⁻ |
| RNH₂⁺CH₂CH₂COO⁻ | (at pH = 7) |
| RNHCH₂CH₂COO⁻B⁺ | (at pH = 12) B⁺ = any cation, e.g. Na⁺ |

Polyether chains are typical of nonionic surfactants. Nonionic surfactants do not form ions in an aqueous medium.

A. Anionic Surfactants

Anionic surfactants which can be used advantageously are
acylamino acids (and salts thereof), such as
   1. acyl glutamates, for example sodium acyl glutamate, di-TEA-palmitoyl aspartate and sodium caprylic/capric glutamate,
   2. acylpeptides, for example palmitoyl-hydrolysed milk protein, sodium cocoyl-hydrolysed soya protein and sodium/potassium cocoyl-hydrolysed coliagen,
   3. sarcosinates, for example myristoyl sarcosinate, TEA-lauroyl sarcosinate, sodium lauroyl sarcosinate and sodium cocoyl sarcosinate,
   4. taurates, for example sodium lauroyl taurate and sodium methylcocoyl taurate,
   5. acyl lactylates, lauroyl lactylate, caproyl lactylate
   6. alaninates
carboxylic acids and derivatives, such as
   1. carboxylic acids, for example lauric acid, aluminium stearate, magnesium alkanolate and zinc undecylenate,
   2. ester carboxylic acids, for example calcium stearoyl lactylate, laureth-6 citrate and sodium PEG-4 lauramide carboxylate,
   3. ether carboxylic acids, for example sodium laureth-13 carboxylate and sodium PEG-6 cocamide carboxylate,
phosphoric esters and salts, such as, for example DEA oleth-10 phosphate and dilaureth-4 phosphate,
sulphonic acids and salts, such as
   1. acyl isethionates, e.g. sodium/ammonium cocoyl isethionate,
   2. alkylarylsulphonates,
   3. alkylsulphonates, for example sodium cocomonoglyceride sulphate, sodium C₁₂₋₁₄-olefinsulphonate, sodium lauryl sulphoacetate and magnesium PEG-3 cocamide sulphate,
   4. sulphosuccinates, for example dioctyl sodium sulphosuccinate, disodium laureth sulphosuccinate, disodium lauryl sulphosuccinate, disodium undecylenamido-MEA sulphosuccinate and PEG-5 lauryl citrate sulphosuccinate.
      and
sulphuric esters, such as
   1. alkyl ether sulphates, for example sodium, ammonium, magnesium, MIPA, TIPA laureth sulphate, sodium myreth sulphate and sodium C₁₂₋₁₃ pareth sulphate,
   2. alkyl sulphates, for example sodium, ammonium and TEA lauryl sulphate.
      B. Cationic Surfactants

Cationic surfactants which can be used advantageously are
1. alkylamines,
2. alkylimidazoles,
3. ethoxylated amines and
4. quaternary surfactants,
   5. ester quats

Quaternary surfactants contain at least one N atom which is covalently bonded to 4 alkyl and/or aryl groups. Irrespective of the pH, this leads to a positive charge. Alkylbetaine, alkylamidopropylbetaine and alkylamidpropylhydroxysultaine are advantageous quaternary surfactants. For the purposes of the present invention, cationic surfactants may also preferably be chosen from the group of quaternary ammonium compounds, in particular benzyltrialkylammonium chlorides or bromides, such as, for example, benzyldimethylstearylammonium chloride, and also alkyltrialkylammonium salts, for example cetyltrimethylammonium chloride or bromide, alkyldimethylhydroxyethylammonium chlorides or bromides, dialkyldimethylammonium chlorides or bromides, alkylamidoethyltrimethylammonium ether sulphates, alkylpyridinium salts, for example lauryl- or cetylpyridinium chloride, imidazoline derivatives and compounds with cationic character, such as amine oxides, for example alkyldimethylamine oxides or alkylaminoethyldimethylamine oxides. In particular, the use of cetyltrimethylammonium salts is advantageous.

C. Amphoteric Surfactants

Amphoteric surfactants which can be used advantageously are
1. acyl/dialkylethylenediamine, for example sodium acyl amphoacetate, disodium acyl amphodipropionate, disodium alkyl amphodiacetate, sodium acyl amphohydroxypropylsulphonate, disodium acyl amphodiacetate and sodium acyl amphopropionate,
2. N-alkylamino acids, for example aminopropylalkylglutamide, alkylaminopropionic acid, sodium alkylimidodipropionate and lauroamphocarboxyglycinate.
   D. Nonionic Surfactants

Nonionic surfactants which can be used advantageously are
1. alcohols,
2. alkanolamides, such as cocamides MEA/DEA/MIPA,
3. amine oxides, such as cocoamidopropylamine oxide,
4. esters which are formed by esterification of carboxylic acids with ethylene oxide, glycerol, sorbitan or other alcohols,
5. ethers, for example ethoxylated/propoxylated alcohols, ethoxylated/propoxylated esters, ethoxylated/propoxylated glycerol esters, ethoxylated/propoxylated cholesterols, ethoxylated/propoxylated triglyceride esters, ethoxylated/propoxylated lanolin, ethoxylated/propoxylated polysiloxanes, propoxylated POE ethers and alkyl polyglycosides, such as lauryl glucoside, decyl glycoside and cocoglycoside.
6. sucrose esters, sucrose ethers
7. polyglycerol esters, diglycerol esters, monoglycerol esters
8. methyl glucose esters, esters of hydroxyl acids

It is also advantageous to use a combination of anionic and/or amphoteric surfactants with one or more nonionic surfactants.

The examples below aim to illustrate the present invention without limiting it. The numerical values in the examples are percentages by weight, based on the total weight of the particular preparations.

### EXAMPLES

1.) O/W Emulsions

| | 1 | 2 | 3 | 4 | 5 | 6 | 7 |
|---|---|---|---|---|---|---|---|
| PEG-40 castor oil, sodium | | | | | | | 2.50 |
| cetearyl sulphate cetearyl | | | | | | | |
| alcohol | | | | | | | |
| Glycerol monostearate (SE) | 1.00 | 2.00 | 3.00 | 1.00 | | 1.50 | |
| Glyceryl stearate citrate | | | | | 2.00 | | |
| Stearic acid | 3.00 | | 2.50 | 2.00 | | | |
| PEG-40 stearate | | 2.00 | | | | 2.00 | |
| PEG-100 stearate | | | 0.75 | | | | |
| Lauryl methicone copolyol | | | | 0.75 | | 0.50 | |
| Sorbitan stearate | | | 0.75 | | | | |
| Cetyl phosphate | | | 0.75 | | | | |
| Stearyl alcohol | | | 3.00 | | 2.00 | 2.00 | 0.50 |
| Cetyl alcohol | 1.00 | 2.00 | | | 0.50 | | 2.00 |
| UVASorb ® K2A | | | | 4.00 | | 5.00 | |
| Uvinul ® A Plus | 2.50 | | | 0.25 | 1.00 | 0.50 | |
| Butylmethoxydibenzoylmethane | | | | | | | 4.00 |
| 4-Methylbenzylidenecamphor | | | 3.00 | | | | |
| Bisethylhexyloxyphenol | 1.00 | | | | | 1.00 | 0.50 |
| methoxyphenyltriazine | | | | | | | |
| Disodium | | | | 1.00 | | 2.00 | |
| phenyldibenzimidazole- | | | | | | | |
| tetrasulphonate | | | | | | | |
| Phenylbenzimidazolesulphonic | | | | | | | 3.00 |
| acid | | | | | | | |
| Ethylhexyl triazone | | | | 2.00 | | 2.00 | |
| Diethylhexylbutamidotriazone | 2.00 | | | | | | |
| Ethylhexyl methoxycinnamate | 3.50 | | | 10.00 | | | |
| Octocrylene | | | | 5.00 | 9.00 | 7.50 | 2.50 |
| Methylenebisbenzotriazolyl- | | | 2.00 | | 3.00 | | |
| tetramethylbutylphenol | | | | | | | |
| Ethylhexy salicylate | | 0.50 | 3.00 | | | | 5.00 |
| Drometrizol trisiloxane | | | 0.50 | | | 1.00 | |
| Terephthalidenedicamphor- | | | | | | 2.00 | |
| sulphonic acid | | | | | | | |
| Dimethylcodiethyl | | | | | | 3.00 | |
| benzalmalonate | | | | | | | |
| Titanium dioxide T 805 | 2.00 | | | | 1.00 | 0.50 | |
| Titanium dioxide MT-100Z | | | | 3.00 | 1.00 | | |
| Zinc oxide Z-Cote HP1 | | | | | | | |
| C₁₂₋₁₅ alkyl benzoate | 2.50 | | | | | 7.00 | 5.00 |
| Dicaprylyl ether | | | 3.50 | | 2.00 | | |
| Caprylic/capric triglyceride | | | | | | | |
| Paraffin oil | | 6.00 | | | | | |
| Butylene glycol dicaprylate/- | | | | 5.00 | 3.00 | | |
| dicaprate | | | | | | | |
| Cetearyl isononanoate | 4.00 | | | | | 2.00 | 2.00 |
| Dimethicone | 0.50 | 3.00 | 1.00 | | 2.00 | | |
| Cyclomethicone | | 3.00 | | 4.50 | | | 0.50 |
| Dimethicone/vinyldimethicone | 4.00 | | | | | | 0.50 |
| crosspolymer | | | | | | | |
| PVP hexadecene copolymer | | | | 0.50 | 1.00 | | 1.00 |
| Glycerol | 7.50 | 10.00 | | 7.50 | 5.00 | | 20.00 |
| Xanthan gum | | 0.20 | 0.05 | | | | 0.30 |
| Polyacrylate (carbomer) | 0.1 | | | 0.25 | 0.1 | 0.2 | |
| Butylene glycol | 5.00 | | | | | 7.00 | |
| Vitamin E acetate | | 0.40 | 0.25 | 0.50 | 0.75 | | 1.00 |
| Dioic acid | | | | 0.20 | | 0.25 | |
| Fucogel ® 1000 | | | 1.50 | | | 5.00 | |
| Dihydroxyacetone | | 5.00 | | | | | |
| DMDM hydantoin | 0.60 | | 0.40 | 0.20 | | | |
| Methylparaben | | 0.10 | 0.25 | | 0.50 | | |
| Phenoxyethanol | 0.40 | 0.50 | | 0.40 | 0.50 | | 0.60 |
| EDTA | 0.20 | | 0.35 | 0.50 | 0.02 | | 0.03 |
| Ethanol | 2.00 | | 1.50 | | 3.00 | 5.00 | 1.00 |
| Insekt repellent 3535 | | | 5.00 | | | | |
| Perfume | 0.20 | 0.20 | | | | 0.30 | 0.40 |
| Water | ad 100 | ad 100 | ad 100 | ad 100 | ad 100 | ad 100 | ad 100 |
| Neutralizing agent (sodium- | qs | qs | qs | qs | qs | qs | qs |
| hydroxide, potassium hydroxide) | | | | | | | |
| pH | 6.0-7.5 | 4.5-7.0 | 6.5-8.5 | 5.0-7.0 | 6.0-8.0 | 4.0-6.0 | 5.0-7.5 |

| | 8 | 9 | 10 | 11 | 12 |
|---|---|---|---|---|---|
| Glycerol monostearate (SE) | | | | 1.00 | |
| Glyceryl stearate citrate | 2.00 | 2.00 | 1.50 | | |
| Polyglyceryl-3 methylglucose | | | | | 4.50 |
| distearate | | | | | |
| Stearyl alcohol | 2.00 | 2.00 | | | |
| Cetyl alcohol | | | 2.00 | | 4.50 |
| UVASorb ® K2A | | | | | |
| Uvinul ® A Plus | | | | | |
| Bisethylhexyloxyphenol | 2.00 | 2.00 | 1.50 | | |
| methoxyphenyltriazine | | | | | |
| Disodium | | | | | |
| phenyldibenzimidazole- | | | | | |
| tetrasulphonate | | | | | |
| Ethylhexyltriazone | | | | | |
| Diethylhexylbutamidotriazone | | 1.00 | 2.00 | | |
| Ethylhexyl methoxycinnamate | 2.00 | 6.00 | 5.00 | | |
| Octocrylene | 2.00 | 9.00 | | | |
| Methylenebisbenzotriazolyl- | | | | | |
| tetramethylbutylphenol | | | | | |
| Ethylhexyl salicylate | | | | | |
| Drometrizol trisiloxane | | | | | |
| Titanium dioxide T 805 | | 3.00 | 2.00 | | |
| C₁₂₋₁₅ alkyl benzoate | | | 3.00 | 1.00 | 1.00 |
| Hydrogenated coconut fatty | 1.00 | 1.00 | 3.00 | | |
| acid glyceride | | | | | |
| Dicaprylyl ether | 5.00 | 2.00 | 6.00 | | |
| Octyldodecanol | 6.00 | 5.00 | 4.00 | 3.00 | 4.00 |
| Butylene glycol dicaprylate/di- | 5.00 | 2.00 | | | |
| caprate | | | | | |
| Caprylic/capric triglyceride | | | | 2.00 | 5.50 |
| Dimethicone | | | 2.00 | | |
| Cyclomethicone | 2.00 | 1.00 | | 3.00 | |
| Sorbitol | | | | 2.50 | |
| Acrylate/C10-30 alkyl acrylate | 0.10 | 0.10 | 0.05 | | |
| crosspolymer | | | | | |
| PVP hexadecane copolymer | 0.50 | 0.50 | | | |
| Glycerol | 8.00 | 6.00 | 5.00 | 3.00 | 3.00 |
| Xanthan gum | 0.40 | 0.40 | 0.25 | 0.30 | 0.10 |
| Butylene glycol | | | 3.00 | 3.00 | |
| Vitamin E acetate | 0.50 | | 0.30 | 0.40 | 0.40 |
| Dihydroxyacetone | | | | 5.00 | 4.00 |
| DMDM hydantoin | 0.60 | 0.60 | 0.50 | | |
| Methylparaben | | | | 0.30 | 0.30 |
| Phenoxyethanol | 0.40 | 0.40 | 0.35 | 0.50 | 0.50 |
| EDTA | 1.00 | 1.00 | 1.00 | | 1.00 |
| Ethanol | | | 3.00 | 3.00 | |
| Insekt repellent 3535 | | | | | |
| Perfume | 0.40 | 0.40 | 0.40 | 0.40 | 0.40 |
| Water | ad 100 | ad 100 | ad 100 | ad 100 | ad 100 |
| Neutralizing agent (sodium | qs | qs | qs | qs | qs |
| hydroxide, potassium | | | | | |
| hydroxide) | | | | | |
| pH | 5.0-7.0 | 5.0-7.0 | 5.0-7.0 | 5.0-7.0 | 5.0-7.0 |

| | 13 | 14 | 15 | 16 | 17 | 18 | 19 |
|---|---|---|---|---|---|---|---|
| Glyceryl stearate, ceteareth-12, | | | | | | | 1.50 |
| ceteareth-20, cetearyl alcohol, | | | | | | | |
| cetyl palmitate | | | | | | | |
| Glycerol monostearate (SE) | | 4.00 | | | | | |
| Glyceryl stearate citrate | 2.00 | | | | | | |
| Polyglyceryl-3 methylglucose | | | | | 2.00 | | |
| distearate | | | | | | | |
| Cetearyl glucoside & cetearyl | | | | | | 2.00 | |
| alcohol | | | | | | | |
| Triceteareth-4 phosphate | | | 1.20 | | | | |
| Trilaureth-4 phosphate | | | | 2.00 | | | |
| Ceteareth-6 | | | 0.50 | 0.50 | | | |
| Sorbitan stearate | | | 0.75 | 1.00 | 1.00 | | |
| Cetyl phosphate | | | | | 2.00 | | |
| Stearyl alcohol | | 2.50 | 3.00 | | | | 1.50 |
| Cetyl alcohol | 2.50 | 1.00 | | | 0.50 | 2.00 | 2.00 |
| UVASorb ® K2A | 1.00 | | | 4.00 | | 5.00 | |
| Uvinul ® A Plus | 3.00 | 2.50 | 0.50 | 0.25 | 1.00 | 0.50 | |
| Butylmethoxydibenzoylmethane | | | | | | | 4.50 |
| Bisethylhexyloxyphenol | | 2.00 | | | | 1.00 | 0.50 |
| methoxyphenyltriazine | | | | | | | |
| Disodium | | | | 1.00 | | 2.00 | |
| phenyldibenzimidazole- | | | | | | | |
| tetrasulphonate | | | | | | | |
| Phenylbenzimidazolesulphonic | | | | | 3.00 | | |
| acid | | | | | | | |
| Ethylhexyltriazone | 2.00 | | | 2.00 | | 2.00 | |
| Diethylhexylbutamidotriazone | | 2.00 | | | | | |
| Ethylhexyl methoxycinnamate | | 3.50 | | 10.00 | | | |
| Octocrylene | | | | 5.00 | 9.00 | 7.50 | 2.50 |
| Methylenebisbenzotriazolyl- | | | 2.00 | | 3.00 | | |
| tetramethylbutylphenol | | | | | | | |
| Ethylhexyl salicylate | | | | | | | 5.00 |
| Drometrizole trisiloxane | | | 0.50 | | | 1.00 | |
| Terephthalidenedicamphor- | | 3.00 | | | | | |
| sulphonic acid | | | | | | | |
| Dimethylcodiethyl | | | 5.00 | | | | |
| benzalmalonate | | | | | | | |
| Titanium dioxide MT-100Z | 1.00 | | | 3.00 | 1.00 | | |
| Zinc oxide Z-cote HP1 | | | | | | 3.00 | |
| Corapan TQ ® | | | | | | | 6.00 |
| C₁₂₋₁₅ alkyl benzoate | | 2.50 | | | | 7.00 | 5.00 |
| Dicaprylyl ether | | | 3.50 | | 2.00 | | |
| Butylene glycol dicaprylate/di- | 5.00 | | | 5.00 | 3.00 | | |
| caprate | | | | | | | |
| Cetearyl isononanoate | | 4.00 | | | | 2.00 | 2.00 |
| Dimethicone | | 0.50 | 1.00 | | 2.00 | | |
| Cyclomethicone | 2.00 | | | 4.50 | | | 0.50 |
| Dimethicone/vinyldimethicone | | 4.00 | | | | | 0.50 |
| crosspolymer | | | | | | | |
| PVP hexadecene copolymer | 0.50 | | | 0.50 | 1.00 | | 1.00 |
| Glycerol | 3.00 | 7.50 | | 7.50 | 5.00 | | 20.00 |
| Xanthan gum | 0.15 | | 0.05 | | | 0.1 | 0.30 |
| Hydroxyethylcellulose | | 0.5 | | | 0.3 | 0.3 | |
| Carbomer | | | 0.05 | 0.2 | | | |
| Butylene glycol | 7.00 | 5.00 | | | | 7.00 | |
| Vitamin E acetate | 0.50 | | 0.25 | 0.50 | 0.75 | | 1.00 |
| Dioic acid | 0.25 | | | 0.20 | | 0.25 | |
| Fucogel ® 1000 | | | 1.50 | | | 5.00 | |
| DMDM hydantoin | | 0.60 | 0.40 | 0.20 | | | |
| Methylparaben | 0.15 | | 0.25 | | 0.50 | | |
| Phenoxyethanol | 1.00 | 0.40 | | 0.40 | 0.50 | | 0.60 |
| EDTA | | 0.20 | 0.35 | 0.50 | 0.02 | | 0.03 |
| Alcohol | | 2.00 | 1.50 | | 3.00 | 5.00 | 1.00 |
| Insekt repellent 3535 | | | 5.00 | | | | |
| Perfume | 0.20 | 0.20 | | | | 0.30 | 0.40 |
| Water | ad 100 | ad 100 | ad 100 | ad 100 | ad 100 | ad 100 | ad 100 |
| Neutralizing agent (NaOH, KOH) | qs | qs | qs | qs | qs | qs | qs |
| pH | 4.5-6.0 | 4.5-7.0 | 5.5-7.5 | 5.0-7.0 | 5.5-7.5 | 4.0-7.0 | 4.0-7.5 |

2.) Foam-Like O/W Emulsions:

| | 1 | | 2 | |
|---|---|---|---|---|
| | % by | % by | % by | % by |
| | wt. | vol. | wt. | vol. |
| Stearic acid | 5.00 | | 1.00 | |
| Cetyl alcohol | 5.50 | | | |
| Cetylstearyl alcohol | | | 2.00 | |
| PEG-40 stearate | 8.50 | | | |
| PEG-20 stearate | | | 1.00 | |
| Caprylic/capric | 4.00 | | 2.00 | |
| triglyceride | | | | |
| C12-15 alkyl | 10.00 | | 15.50 | |
| benzoate | | | | |
| Cyclomethicone | 4.00 | | | |
| Dimethicone | | | 0.50 | |
| Octyl isostearate | | | 5.00 | |
| Magnesium aluminium | 0.2 | 0.1 | 0.05 | 0.5 |
| sheet silicate | | | | |
| Carbomer | 0.2 | 0.1 | 0.2 | 0.1 |
| Myristyl myristate | | | 2.00 | |
| Ceresine | 1.50 | | | |
| Glycerol | 5.00 | | 10.00 | |
| UVASorb ® K2A | 2.00 | | | |
| Uvinol A Plus ® | 2.00 | | 1.50 | |
| Terephthalidene- | 0.50 | | | |
| dicamphor | | | | |
| sulphonic acid | | | | |
| Drometrizole | 1.50 | | | |
| trisiloxane | | | | |
| Ethylhexyl | 5.00 | | 4.00 | |
| methoxycinnamate | | | | |
| Ethylhexyltriazone | | | 3.00 | |
| Octocrylene | 5.00 | | | |
| Titanium dioxide | 1.00 | | | |
| Uvinol T 805 | | | | |
| BHT | | | 0.02 | |
| Na₂H₂EDTA | 0.50 | | 0.10 | |
| Perfume, preservative, | qs | | qs | |
| Dyes, etc. | qs | | qs | |
| Potassium hydroxide | qs | | qs | |
| Water | ad 100.00 | | ad 100.00 | |
| | pH adjusted to | | pH adjusted to | |
| | 6.5-7.5 | | 5.0-6.0 | |
| Emulsion 1 | | 70 | | |
| Emulsion 2 | | | | 35 |
| Gas (nitrogen, oxygen | | 30 | | |
| or carbon dioxide) | | | | |
| Gas (air) | | | | 65 |

| | Emulsion | | |
|---|---|---|---|
| | 3 | 4 | 5 |
| Stearic acid | 2.00 | 2.00 | |
| Palmitic acid | | | 1.50 |
| Cetyl alcohol | 2.50 | 2.00 | |
| Stearyl alcohol | | | 3.00 |
| PEG-100 stearate | | | 3.50 |
| PEG-40 stearate | | 2.00 | |
| PEG-20 stearate | 3.00 | | |
| Sorbitan stearate | | 0.80 | |
| C12-15 alkyl benzoate | 5.00 | | |
| C12-13 alkyl tartrate | | | 7.00 |
| Butylene glycol | | 6.00 | |
| dicaprylate/dicaprate | | | |
| Dicaprylyl ether | | | 2.00 |
| Cyclomethicone | | 2.00 | 3.00 |
| Butylene glycol | 1.00 | | |
| Isohexadecane | 2.00 | | |
| Methylpropanediol | | | |
| Propylene glycol | | | 5.00 |
| Hydroxyethylcellulose | 0.1 | 0.05 | 0.1 |
| Magnesium aluminium sheet | 0.3 | 0.5 | 0.5 |
| silicates | | | |
| Glycerol | 5.00 | 7.00 | |
| UVASorb ® K2A | | | 2.00 |
| Uvinul A Plus ® | 2.00 | | |
| NeoHeliopan ® AP | | | |
| Phenylbenzimidazolesulphonic | | | |
| acid | | | |
| Ethylhexyl methoxycinnamate | | | |
| Ethylhexyltriazone | 2.00 | 2.00 | 2.00 |
| Octocrylene | 2.00 | | |
| Bisethylhexyloxyphenol | | 3.00 | 3.00 |
| methoxyphenyltriazine | | | |
| Vitamin E acetate | | 0.5 | |
| BHT | | | 0.10 |
| Na₂H₂EDTA | 0.50 | | |
| Perfume, preservative | Qs | qs | qs |
| Dyes, etc. | Qs | qs | qs |
| Sodium hydroxide | Qs | | qs |
| Potassium hydroxide | | qs | |
| Water | ad 100.0 | ad 100.0 | ad 100.0 |

| | Emulsion | | | |
|---|---|---|---|---|
| | 6 | 7 | 8 | 9 |
| Stearic acid | 1.50 | | | |
| Palmitic acid | | | 3.00 | 3.00 |
| Cetyl alcohol | | 3.00 | | |
| Cetylstearyl alcohol | | | 2.00 | 2.00 |
| Stearyl alcohol | 3.00 | | | |
| PEG-100 stearate | | 4.00 | | |
| PEG-40 stearate | 3.00 | | | |
| PEG-20 stearate | | | 3.00 | 3.00 |
| Sorbitan stearate | 1.00 | | | |
| Tridecyl trimellitate | | 5.00 | | |
| C12-15 alkyl benzoate | | | 3.00 | 3.00 |
| Butylene glycol | 8.00 | | | |
| dicaprylate/di- | | | | |
| caprate | | | | |
| Octyldodecanol | | 2.00 | | |
| Coconut fatty | | | | 2.00 |
| acid glyceride | | | | |
| Dicaprylyl ether | | | 2.00 | 2.00 |
| Cyclomethicone | | | | |
| Dimethicone | 1.00 | | 2.00 | 2.00 |
| Isohexadecane | | 3.00 | | |
| Methylpropanediol | | 4.00 | | |
| Propylene glycol | | | | |
| Glycerol | 5.00 | | 6.00 | 6.00 |
| Carbomer | 0.1 | | 0.2 | |
| C10-30 alkyl | | 0.25 | | 0.3 |
| acrylate | | | | |
| crosspolymer | | | | |
| NeoHeliopan ® AP | | 2.00 | | |
| Phenylbenzimidazole- | 1.00 | 4.00 | 1.00 | 1.00 |
| sulphonic acid | | | | |
| Ethylhexyl | 5.00 | | 4.00 | 4.00 |
| methoxycinnamate | | | | |
| Ethylhexyltriazone | | | | |
| Diethylhexylbutamido- | 1.00 | | | |
| triazone | | | | |
| Butylmethoxydi- | 2.50 | | 2.00 | 2.00 |
| benzoylmethane | | | | |
| Bisethylhexyloxyphenol | 2.00 | | | |
| methoxyphenoltriazine | | | | |
| Vitamin E acetate | 0.20 | | 0.30 | 0.30 |
| BHT | | 0.05 | | |
| Na₂H₂EDTA | | | 0.40 | 0.40 |
| Perfume, preservative | qs | qs | qs | qs |
| Dyes, etc. | qs | qs | qs | qs |
| Sodium hydroxide | qs | qs | qs | qs |
| Potassium hydroxide | | | | qs |
| Water | ad 100.0 | ad 100.0 | ad 100.0 | ad 100.0 |

To produce the foam, 80-97% by volume of emulsion I are foamed with 3-20% by volume of a suitable gas (e.g. propane/butane, compressed air, nitrogen).

3.) Hydrodispersions

| | 1 | 2 | 3 | 4 | 5 | 6 |
|---|---|---|---|---|---|---|
| Glyceryl stearate citrate | | 0.40 | | | | |
| Cetyl alcohol | | | | | 2.00 | |
| Sodium carbomer | | | | | 0.30 | |
| Acrylates/C10-30 alkyl | | | 0.30 | 0.40 | 0.10 | 0.10 |
| acrylate crosspolymer | | | | | | |
| Ceteareth-20 | | | 1.00 | | | |
| Xanthan gum | 0.50 | 0.30 | | 0.15 | | 0.50 |
| Dimethicone/vinyldimethicone | | | | 5.00 | | 3.00 |
| crosspolymer | | | | | | |
| UVASorb ® K2A | | | | | 3.50 | |
| Uvinul ® A Plus | 0.25 | | | 0.50 | 2.00 | 1.50 |
| Butylmethoxydibenzoyl- | | | 3.50 | | | |
| methane | | | | | | |
| Bisethylhexyloxyphenol | | 2.00 | | 0.25 | | |
| methoxyphenyltriazine | | | | | | |
| Terephthalidenedicamphor- | | | | | | 0.50 |
| sulphonic acid | | | | | | |
| Disodium phenyldibenz- | 0.75 | | | | | 1.00 |
| imidazole tetrasulphonate | | | | | | |
| Phenylbenzimidazole- | | | 2.00 | | | |
| sulphonic acid | | | | | | |
| Ethylhexyl methoxycinnamate | | | 7.00 | | 5.00 | 8.00 |
| Methylenebisbenzotriazolyl- | | | | | | |
| tetramethylbutylphenol | | | | | | |
| Butylmethoxydibenzoyl- | | 3.50 | | | | |
| methane | | | | | | |
| Diethylhexylbutamidotriazone | | | 2.00 | 2.00 | | |
| Ethylhexyltriazone | 4.00 | 3.00 | | | 4.00 | |
| Octocrylene | | | | 10.00 | | 2.50 |
| Titanium dioxide MT-100 Z | 0.50 | 2.00 | 1.00 | 2.00 | 3.00 | 1.00 |
| C₁₂₋₁₅ alkyl benzoate | 2.00 | | 2.50 | | | |
| C18-36 triglyceride fatty acid | | | 1.00 | | | |
| Butylene glycol | 4.00 | | | | 6.00 | |
| dicaprylate/dicaprate | | | | | | |
| Dicaprylyl carbonate | | 3.00 | | | | |
| Dicaprylyl ether | | 2.00 | | | | |
| Cyclomethicone | | | | 7.50 | | |
| Lanolin | | | | | 0.35 | |
| PVP hexadecene copolymer | 0.50 | | 0.50 | | 0.50 | 1.00 |
| Ethylhexyloxyglycerol | | 0.75 | | 1.00 | | 0.50 |
| Glycerol | 10.00 | 5.00 | 5.00 | | 5.00 | 15.00 |
| Butylene glycol | | 7.00 | | | | |
| Glycine soya | | | | 1.00 | | |
| Vitamin E acetate | 0.50 | 0.25 | 0.50 | 0.25 | 0.75 | 1.00 |
| α-Glycosylrutin | | | | | 0.25 | |
| Trisodium EDTA | | 1.00 | 1.00 | 0.10 | 0.20 | |
| Dekaben LMB ® | 0.20 | 0.10 | | | | 0.15 |
| Methylparaben | 0.50 | | 0.20 | | 0.15 | |
| Phenoxyethanol | 0.50 | 0.40 | 0.40 | | 1.00 | 0.60 |
| Ethanol | 3.00 | 10.00 | 4.00 | 3.50 | | 1.00 |
| Perfume, dyes | qs | qs | qs | qs | qs | qs |
| Water | ad 100 | ad 100 | ad 100 | ad 100 | ad 100 | ad 100 |
| Neutralizing agent (sodium | qs | qs | qs | qs | qs | qs |
| hydroxide, potassium hydroxide) | | | | | | |
| pH | 4.5-5.5 | 5.0-7.0 | 5.0-7.0 | 5.0-7.0 | 4.0-6.0 | 5.0-7.5 |

4.) Gel Creams

| | 1 | 2 | 3 | 4 | 5 |
|---|---|---|---|---|---|
| Carbomer | 0.125 | 0.125 | 0.125 | 0.125 | 0.125 |
| Shea butter | | | | 1.00 | |
| Mineral oil | | | | | 6.00 |
| Octyldodecanol | | | | 1.50 | |
| Caprylic/capric | | | 4.00 | | |
| triglyceride | | | | | |
| Dicaprylyl carbonate | | 9.00 | | 1.00 | 3.00 |
| Dimethicone | | | | 0.50 | |
| Cyclomethicone | 9.00 | 2.00 | 3.00 | 2.00 | 1.00 |
| Diazolidinylurea | 0.20 | 0.20 | 0.20 | 0.20 | 0.20 |
| Phenoxyethanol + | 0.50 | 0.50 | 0.50 | 0.50 | 0.50 |
| ethyl-, methyl-, propyl-, | | | | | |
| butyl-, isobutylparaben | | | | | |
| Perfume | | | | 0.25 | 0.25 |
| Glyceryl stearate citrate | 1.00 | 1.00 | 1.00 | 1.00 | 1.00 |
| Hydrogenated coconut | 1.00 | 1.00 | 1.00 | 1.00 | 1.00 |
| fatty acid glyceride | | | | | |
| Ammonium acryloyl- | | | | | 0.125 |
| dimethyltaurate/VP | | | | | |
| copolymer | | | | | |
| Hydroxyethylcellulose | 0.375 | 0.375 | 0.375 | 0.375 | 0.375 |
| Menthol | 0.10 | 0.50 | 1.00 | 0.10 | 0.10 |
| Water + alcohol denat. | | | | 3.00 | |
| Water + Blue 1 | | 0.200 | 0.60 | 0.40 | |
| Water + glycerol | 10.00 | 10.00 | 10.00 | 10.00 | 10.00 |
| Xanthan gum | 0.125 | 0.125 | 0.125 | 0.125 | |
| Water | ad 100.0 | ad 100.0 | ad 100.0 | ad 100.0 | ad 100.0 |
| Neutralizing agent (sodium hydroxide, | qs | qs | qs | qs | qs |
| potassium hydroxide) | | | | | |
| pH | 4.5-5.5 | 6.5-8.5 | 5.0-7.0 | 4.0-6.0 | 5.0-7.5 |

5.) Solids-Stabilized Emulsions

| | 1 | 2 | 3 | 4 | 5 |
|---|---|---|---|---|---|
| Mineral oil | | | 16.00 | 16.00 | |
| Octyldodecanol | 9.00 | 9.00 | 5.00 | | |
| Caprylic/capric triglyceride | 9.00 | 9.00 | 6.00 | | |
| C12-15 alkylbenzoate | | | | 5.00 | 8.00 |
| Butylene glycol dicaprylate/ | | | | | 8.00 |
| dicaprate | | | | | |
| Dicaprylyl ether | 9.00 | | | 4.00 | |
| Dicaprylyl carbonate | | 9.00 | | | |
| Hydroxyoctacosanyl | 2.00 | 2.00 | 2.00 | 2.00 | 1.50 |
| hydroxystearate | | | | | |
| Disteardimonium hectorite | 1.00 | 0.750 | 0.50 | 0.50 | 0.25 |
| Ceramicrocrystallina + | | | 2.50 | | 5.00 |
| paraffin oil | | | | | |
| Hydroxypropylmethyl- | 0.15 | | | | 0.05 |
| cellulose | | | | | |
| Xanthan gum | | 0.3 | | | |
| Dimethicone | | | 4.50 | | |
| UVASorb ® K2AQ | 2.00 | 5.00 | 3.00 | 1.50 | 1.00 |
| Bisethylhexyloxyphenol | 1.00 | 3.00 | 0.75 | 1.00 | 1.00 |
| methoxyphenyltriazine | | | | | |
| Terephthalidenedicamphor- | | 2.00 | | | 0.50 |
| sulphonic acid | | | | | |
| Phenylbenzimidazole- | 2.00 | 0.50 | 1.00 | | |
| sulphonic acid | | | | | |
| Uvinul ® A Plus | | | 2.75 | | 0.50 |
| Ethylhexyl | 6.00 | | | | 3.0 |
| methoxycinnamate | | | | | |
| Octocrylene | 3.50 | | 7.50 | | |
| Ethylhexyl salicylate | | 3.50 | | | 4.00 |
| Diethylhexylbutamidotriazone | | | | | 4.0 |
| Titanium dioxide Eusolex ® | | 2.00 | 4.00 | 2.00 | 4.00 |
| T-2000 | | | | | |
| Titanium dioxide T 805 ® | | | | | 3.00 |
| Silica dimethyl silylate | | | 1.00 | | |
| Boron nitride | 2.00 | | | 3.00 | |
| Tapioca starch | | | | 1.00 | |
| Sodium chloride | 1.00 | 1.00 | 1.00 | 1.00 | |
| Glycerol | 5.0 | 10.0 | | 6.00 | 10.0 |
| Trisodium EDTA | | 1.00 | | 1.00 | |
| Methylparaben | 0.21 | | | | 0.20 |
| Propylparaben | 0.07 | | | | |
| Phenoxyethanol | 0.50 | | 0.40 | 0.40 | 0.50 |
| Hexamidine diisethionate | | | | | 0.08 |
| Diazolidinylurea | | | 0.28 | 0.28 | |
| Alcohol | | 5.00 | | 2.50 | |
| Perfume | 0.45 | 0.20 | | | 0.45 |
| Water | ad 100 | ad 100 | ad 100 | ad 100 | ad 100 |

6.) Gels:

% by wt.

Eye shadow gel

| | |
|---|---|
| PEG-8 (polyethylene glycol 400) | 2.00 |
| Ethanol | 5.00 |
| Aristoflex AVC | 1.50 |
| Glycerol | 2.00 |
| Panthenol | 0.50 |
| Tocopherol acetate | 0.50 |
| Timiron Splendid Blue ® (Merck KgaA) | 4.50 |
| Chromium oxide green | 1.00 |
| Perfume, preservative, NaOH, complexing | qs |
| agent, dyes, antioxidants etc. | |
| Water | ad 100.00 |

Highlighter gel

| | |
|---|---|
| Carbomer | 1.50 |
| Glycerol | 2.50 |
| 1,3-Butylene glycol | 2.50 |
| Glitter pigments (e.g. Helicone HC Scarebeus, Wacker) | 1.00 |
| EDTA | 0.20 |
| Dimethicones | 1.50 |
| Perfume, preservative, NaOH, | qs |
| dyes, antioxidants, etc. | |
| Water | ad 100.00 |

Eye liner gel

| | |
|---|---|
| Pearlescent pigments | 10.00 |
| Iron oxide | 3.00 |
| Silica | 2.00 |
| Aristoflex AVC | 1.00 |
| Hydroxypropylethylcellulose | 0.35 |
| Citric acid | qs |
| Glycerol | 5.00 |
| PVP/VA copolymer | 2.00 |
| Perfume, preservative, dyes, NaOH, | qs |
| complexing agent, antioxidants, etc. | |
| Water | ad 100.00 |

7.) Make-Up

% by wt.

Emulsion make-up

| | |
|---|---|
| PEG-30 stearate | 2.00 |
| Glycerol monostearate | 1.00 |
| Stearic acid | 1.00 |
| Cyclomethicone | 7.00 |
| Octyldodecanol | 7.00 |
| Isopropyl lanolate | 4.00 |
| Squalane | 2.00 |
| Octyl methoxycinnamate | 2.00 |
| Butylmethoxydibenzoylmethane | 1.00 |
| Xanthan gum | 0.20 |
| Glycerol | 5.00 |
| Butylene glycol | 2.00 |
| Vitamin E acetate | 1.00 |
| Magnesium silicate | 1.00 |
| Mica | 1.00 |
| Iron oxide | 1.00 |
| Titanium dioxide | 2.50 |
| Talc | 5.00 |
| EDTA | 0.50 |
| Perfume, preservative, NaOH, antioxidants, etc. | qs |
| Water | ad 100.00 |
| Cyclomethicone and PEG/PPG - 18/18 | 10.00 |
| dimethicone (e.g. Dow Corning 3225 | |
| Formulation Aid) | |
| Cyclomethicone | 10.00 |
| Beeswax | 3.00 |
| Polyglyceryl-4 oleate | 2.00 |
| Quaternium-18 hectorite | 0.50 |
| Microcrystalline cellulose | 0.50 |
| Iron oxide | 1.00 |
| Titanium dioxide | 2.50 |
| Talc | 12.00 |
| Sodium chloride | 2.00 |
| Perfume, preservative, NaOH, antioxidants, etc. | qs |
| Water | ad 100.00 |

Cover cream

| | |
|---|---|
| Cyclomethicone | 44.00 |
| Beeswax | 3.00 |
| Carnauba wax | 10.00 |
| Lanolin oil | 5.00 |
| Paraffin oil | 8.40 |
| Quaternium-18 hectorite | 2.00 |
| Cetyl alcohol | 2.60 |
| Iron oxide | 3.00 |
| Titanium dioxide | 7.50 |
| Nylon | 6.00 |
| Talc | 10.50 |
| Perfume, preservative, NaOH, antioxidants, etc. | qs |

Emulsion make-up

| | |
|---|---|
| Cyclomethicone | 18.00 |
| Phenyltrimethicone | 3.00 |
| Cetyl PEG/PPG-10/1 dimethicone (e.g. Abil EM 90) | 4.00 |
| Paraffin oil | 3.00 |
| Microcrystalline cellulose | 0.50 |
| Iron oxide | 2.30 |
| Titanium dioxide | 4.50 |
| Talc | 2.00 |
| Sodium chloride | 2.00 |
| Quaternium-18 hectorite | 0.30 |
| Propylene carbonate | 0.08 |
| Perfume, preservative, NaOH, antioxidants, etc. | qs |
| Water | ad 100.00 |

8.) Cleansing Emulsion (O/W)

| | 1 | 2 | 3 | 4 | 5 |
|---|---|---|---|---|---|
| Sodium lauryl ether sulphate | 10 | 9 | 8 | — | 10 |
| Sodium myrystyl ether sulphate | | | | 8 | |
| Alkylamidopropylbetaine | — | 3 | 5 | 2 | — |
| Sodium acyl glutamate | — | — | 2 | — | — |
| Alkyl polyglucoside | — | — | — | 2 | 1.5 |
| Acrylate copolymer (Acrylates/ | 0.65 | 0.5 | 0.3 | 0.6 | 0.7 |
| C 10-30 Alkyl Acrylate | | | | | |
| Crosspolymer) | | | | | |
| Phenoxyethanol + | 0.8 | 0.8 | 0.8 | 0.8 | 0.8 |
| methylparaben + butylparaben + | | | | | |
| ethylparaben + | | | | | |
| isobutylparaben + | | | | | |
| propylparaben | | | | | |
| Soya oil | 6 | 40 | 25 | — | 30 |
| Paraffin oil | 35 | 5 | 18 | 45 | 13 |
| Almond oil | 2 | — | — | — | — |
| Quaternary ammonium salt of | — | — | 0.10 | — | — |
| hydroxyethylcellulose | | | | | |
| Ethoxylated glycerol fatty acid | — | 0.5 | — | 1 | 1 |
| esters (PEG-7 glyceryl cocoate) | | | | | |
| Unispheres (lactose + cellulose + | 0.2 | — | — | — | — |
| hydroxypropylmethylcellulose + | | | | | |
| Cl 77007) | | | | | |
| NaOH | qs | qs | qs | qs | qs |
| Perfume | 1.0 | 1.2 | 1.0 | 1.0 | 0.8 |
| Water | ad 100 | ad 100 | ad 100 | ad 100 | ad 100 |

9.) Shower Gel

| | 1 | 2 | 3 | 4 | 5 | 6 | 7 | 8 | 9 | 10 |
|---|---|---|---|---|---|---|---|---|---|---|
| Sodium myrystyl | — | — | — | — | — | — | — | — | — | 4 |
| ether sulphate | | | | | | | | | | |
| Sodium lauryl | 13.0 | 11.0 | 9.0 | 8.5 | 12.0 | 10 | 11 | — | 10 | — |
| ether sulphate | | | | | | | | | | |
| Alkylamidopropyl- | 0.50 | 1.5 | 2.0 | 1.0 | | 4.0 | 2.5 | 4.0 | 4.0 | 4.5 |
| betaine | | | | | | | | | | |
| Alkyl poly- | — | — | — | — | 1.10 | — | — | 4.0 | | 1.0 |
| glucoside | | | | | | | | | | |
| Sodium cocoyl | 1.50 | 0.5 | 1.0 | 0.5 | 0.75 | — | 3.0 | 1.5 | 2.0 | — |
| glutamate | | | | | | | | | | |
| Acrylate | 3.00 | 1.50 | 1.75 | 2.00 | 2.20 | 2.40 | 3.5 | 2.8 | 2.4 | — |
| copolymer | | | | | | | | | | |
| (Acrylates | | | | | | | | | | |
| Copolymer) | | | | | | | | | | |
| Quaternary | — | — | — | 0.20 | — | — | — | — | — | — |
| ammonium salt | | | | | | | | | | |
| of hydroxyethyl- | | | | | | | | | | |
| cellulose | | | | | | | | | | |
| PEG-6 caprylic/ | — | 0.75 | 1.0 | — | — | 1.0 | — | — | — | — |
| capric glycerides | | | | | | | | | | |
| PEG-40 | 1.0 | 1.0 | 1.0 | 1.0 | 1.0 | 1.0 | 1.0 | 1.2 | 0.7 | — |
| hydrogenated | | | | | | | | | | |
| castor oil | | | | | | | | | | |
| PEG-200 | — | — | — | 0.1 | — | — | — | — | — | 1.0 |
| hydrogenated | | | | | | | | | | |
| glycerol palmitic | | | | | | | | | | |
| acid ester | | | | | | | | | | |
| Glycol distearate | 1.0 | — | — | — | — | — | — | — | | — |
| Styrene/acrylate | — | 0.5 | — | — | — | — | — | — | 0.5 | — |
| copolymer | | | | | | | | | | |
| DMDM hydantoin | 0.30 | 0.30 | 0.30 | 0.30 | | 0.30 | 0.30 | 0.30 | | |
| Methylparaben | — | — | — | — | 0.40 | — | — | — | 0.40 | 0.40 |
| Propylparaben | — | — | — | — | 0.20 | — | — | — | 0.20 | 0.20 |
| Phenoxyethanol | — | — | — | — | 0.60 | — | — | — | 0.60 | 0.60 |
| Unispheres | 0.3 | — | — | — | — | 0.20 | — | — | — | 0.1 |
| (lactose + | | | | | | | | | | |
| cellulose + | | | | | | | | | | |
| hydroxyl- | | | | | | | | | | |
| propylmethyl- | | | | | | | | | | |
| cellulose + | | | | | | | | | | |
| Cl 77007) | | | | | | | | | | |
| Polyethylene | — | — | — | — | — | — | — | — | 0.2 | — |
| Water + | — | 0.05 | — | — | — | — | — | — | — | — |
| Cl 42051 | | | | | | | | | | |
| Citric acid | qs | qs | qs | qs | qs | qs | qs | qs | qs | qs |
| NaOH | qs | qs | qs | qs | qs | qs | qs | qs | qs | qs |
| Perfume | 1.0 | 0.5 | 1.2 | 1.0 | 0.8 | 1.0 | 0.8 | 1.0 | 1.0 | 0.5 |
| Water | ad | ad | ad | ad | ad | ad | ad | ad | ad | ad |
| | 100 | 100 | 100 | 100 | 100 | 100 | 100 | 100 | 100 | 100 |

10.) Cleansing Gel

| | 1 | 2 | 3 |
|---|---|---|---|
| Sodium lauryl ether sulphate | 5 | | 3 |
| Sodium myrystyl ether sulphate | | 2 | |
| Alkylamidopropylbetaine | — | 2 | 0.5 |
| Alkyl polyglucoside | 0.5 | — | 0.3 |
| Acrylate copolymer (carbomer) | 1.2 | 1.0 | 1.5 |
| Xanthan gum | 0.25 | 0.10 | — |
| Phenoxyethanol + methylparaben + | 0.8 | 0.8 | 0.8 |
| butylparaben + ethylparaben + | | | |
| isobutylparaben + propylparaben | | | |
| Glycerol | 1.5 | 1.0 | — |
| Almond oil | — | 0.1 | — |
| Quaternary ammonium salt of | — | — | 0.10 |
| hydroxyethylcellulose | | | |
| Ethoxylated glycerol fatty acid esters (PEG-7 | 0.5 | 0.5 | — |
| glyceryl cocoate) | | | |
| Unispheres (lactose + cellulose + | — | — | 0.2 |
| hydroxypropylmethylcellulose + Cl 77007) | | | |
| NaOH | qs | qs | qs |
| Perfume | 0.5 | 0.6 | 1.0 |
| Water | ad 100 | ad 100 | ad 100 |

11.) Shower Peeling

| | 1 | 2 | 3 |
|---|---|---|---|
| Sodium lauryl ether sulphate | 15 | 8 | 10 |
| Sodium myrystyl ether sulphate | — | 2 | — |
| Alkyl amphoacetate | 4.0 | — | 5.0 |
| Alkylamidopropylbetaine | — | 2 | 0.5 |
| Alkyl polyglucoside | — | — | 0.5 |
| Magnesium aluminium silicates | 2.5 | 2.0 | 2.3 |
| Polyethylene | 5.0 | 2.5 | 5.0 |
| Phenoxyethanol + methylparaben + | 0.8 | 0.8 | 0.8 |
| butylparaben + ethylparaben + | | | |
| isobutylparaben + propylparaben | | | |
| Almond oil | — | 0.1 | — |
| Quaternary ammonium salt of | 0.2 | — | 0.10 |
| hydroxyethylcellulose | | | |
| Ethoxylated glycerol fatty acid | 0.5 | 0.5 | — |
| esters (PEG-7 glyceryl cocoate) | | | |
| Unispheres (lactose + cellulose + | 0.2 | 0.2 | 0.2 |
| hydroxypropylmethylcellulose + | | | |
| Cl 77007) | | | |
| Citric acid | qs | qs | qs |
| Perfume | 0.8 | 0.6 | 1.0 |
| Water | ad 100 | ad 100 | ad 100 |

12.) Shampoos

Conditioner shampoo

| | 1 | 2 | 3 | 4 | 5 |
|---|---|---|---|---|---|
| Sodium lauryl ether | 9 | 9 | 9 | 9 | 9 |
| sulphate | | | | | |
| Cocamidopropylbetaine | 4 | 4 | 4 | 4 | 4 |
| Disodium PEG-5 lauryl | 3 | 3 | 3 | 3 | 3 |
| citrate sulphosuccinate | | | | | |
| Acrylate copolymer | 2.0 | 2.0 | 3.0 | 3.0 | 3.0 |
| (Acrylates Copolymer) | | | | | |
| Polyquaternium-10 | 0.3 | 0.1 | 0.1 | 0.3 | — |
| Guar hydroxypropyl- | — | — | 0.1 | 0.2 | 0.2 |
| trimonium chloride | | | | | |
| Pearlescence | 1.5 | 3 | 4 | 2 | 2.5 |
| Opacifier | — | — | — | — | 0.5 |
| Iminodisuccinic acid | 0.1 | 0.2 | 0.1 | 0.5 | 0.5 |
| PEG-40 hydrogenated | 0.2 | 0.2 | 0.2 | 0.2 | 0.2 |
| castor oil | | | | | |
| Unispheres (lactose + | — | — | 0.3 | — | — |
| cellulose + hydroxypropyl- | | | | | |
| methylcellulose + | | | | | |
| Cl 77007) | | | | | |
| Sodium salicylate | 0.4 | 0.4 | 0.4 | 0.4 | 0.4 |
| Sodium benzoate | 0.4 | 0.4 | 0.4 | 0.4 | 0.4 |
| Sodium chloride | 0.9 | 1.0 | 1.2 | — | — |
| Citric acid | qs | qs | qs | qs | qs |
| Perfume | qs | qs | qs | qs | qs |
| Water | ad 100 | ad 100 | ad 100 | ad 100 | ad 100 |

Clear conditioning shampoo

| | 1 | 2 | 3 | 4 | 5 |
|---|---|---|---|---|---|
| Sodium lauryl ether | 10 | 9 | 3.5 | 3.5 | 0.5 |
| sulphate | | | | | |
| Sodium myreth sulphate | — | — | 3.5 | 3.5 | 3.0 |
| Cocamidopropylbetaine | 4 | 4.5 | 3 | — | — |
| Sodium | — | — | — | 2.5 | — |
| cocoamphoacetate | | | | | |
| Disodium PEG-5 lauryl | — | — | — | — | 2.5 |
| citrate sulphosuccinate | | | | | |
| Decyl glucoside | — | — | — | — | 4.5 |
| Acrylate copolymer | 2.5 | 2.5 | 3.0 | 3.5 | 3.0 |
| (Acrylates Copolymer) | | | | | |
| Polyquaternium-10 | 0.1 | 0.1 | 0.05 | 0.25 | 0.2 |
| Guar hydroxypropyl- | — | 0.1 | — | — | 0.2 |
| trimonium chloride | | | | | |
| Hydrolysed silk protein | — | — | — | — | 0.3 |
| Iminodisuccinic acid | 0.1 | 0.1 | 0.2 | — | — |
| PEG-40 hydrogenated | 0.2 | 0.2 | 0.2 | 0.1 | 0.2 |
| castor oil | | | | | |
| Unispheres (lactose + | — | 0.2 | — | — | — |
| cellulose + hydroxypropyl- | | | | | |
| methylcellulose + | | | | | |
| Cl 77007) | | | | | |
| Sodium salicylate | — | — | 0.4 | — | |
| Sodium benzoate | 0.5 | 0.5 | 0.4 | 0.4 | 0.4 |
| Benzophenone-4 | — | — | 0.1 | — | — |
| Citric acid | qs | qs | qs | qs | qs |
| Perfume | qs | qs | qs | qs | qs |
| Water | ad 100 | ad 100 | ad 100 | ad 100 | ad 100 |

Mild baby shampoo

| | 1 | 2 | 3 | 4 | 5 |
|---|---|---|---|---|---|
| Sodium myristyl ether | 4 | 4 | 5 | 5 | 4 |
| sulphate | | | | | |
| Decyl glucosides | 4 | 4 | 4 | 4 | 4 |
| Disodium PEG-5 lauryl | 4 | 4 | 3 | 5 | 5 |
| citrate sulphosuccinate | | | | | |
| PEG-80 sorbitan laurate | 2 | 1 | 1 | — | 0.5 |
| Acrylate copolymer | 2.5 | 3.2 | 3.5 | 2.0 | 3.0 |
| (Acrylates Copolymer) | | | | | |
| Polyquaternium-10 | 0.3 | 0.1 | 0.1 | 0.3 | — |
| Guar hydroxypropyl- | — | — | 0.1 | 0.2 | 0.2 |
| trimonium chloride | | | | | |
| Pearlescence | — | — | 4 | 2 | 2.5 |
| Opacifier | — | — | — | — | 0.5 |
| Iminodisuccinic acid | — | 0.2 | 0.1 | 0.5 | 0.5 |
| PEG-40 hydrogenated castor | 0.2 | 0.2 | 0.2 | 0.2 | 0.2 |
| oil | | | | | |
| Sodium salicylate | 0.4 | 0.4 | 0.4 | 0.4 | 0.4 |
| Sodium benzoate | 0.4 | 0.4 | 0.4 | 0.4 | 0.4 |
| Sodium chloride | 0.9 | 1.0 | 1.2 | — | — |
| Citric acid | qs | qs | qs | qs | qs |
| Perfume | qs | qs | qs | qs | qs |
| Water | ad 100 | ad 100 | ad 100 | ad 100 | ad 100 |

| | Antidandruff shampoo/mild scalp shampoo | | | | | |
|---|---|---|---|---|---|---|
| | 1 | 2 | 3 | 4 | 5 | 6 |
| Sodium lauryl ether | 9 | 9 | 9 | 9 | 10 | — |
| sulphate | | | | | | |
| Sodium myristyl ether | — | — | — | — | — | 6 |
| sulphate | | | | | | |
| Cocamidopropylbetaine | 4 | 4 | 4 | 4 | 4 | — |
| Disodium PEG-5 lauryl | 3 | 3 | 3 | 3 | — | — |
| citrate sulphosuccinate | | | | | | |
| Sodium | — | — | — | — | — | 2.5 |
| cocoamphoacetate | | | | | | |
| Decyl glucoside | — | — | — | — | — | 2.5 |
| Acrylate copolymer | 2.5 | 2.8 | 3.0 | 3.0 | 3.5 | 3.5 |
| (Acrylates Copolymer) | | | | | | |
| Polyquaternium-10 | 0.3 | 0.1 | 0.1 | 0.3 | 0.1 | 0.3 |
| Guar hydroxypropyl- | — | — | 0.1 | 0.2 | — | — |
| trimonium chloride | | | | | | |
| Climbazole | 0.5 | 0.5 | — | 0.5 | 1.0 | — |
| Piroctone olamine | — | 0.5 | 0.3 | — | 0.5 | — |
| Laureth-9 | — | — | — | — | 2 | 2 |
| Panthenol | — | — | — | — | — | 1 |
| Urea | | | | | | 5 |
| Pearlescence | 1.5 | 3 | 4 | 2 | 2.5 | — |
| Opacifier | — | — | — | — | 0.5 | — |
| Iminodisuccinic acid | 0.1 | 0.2 | 0.1 | 0.5 | 0.5 | — |
| PEG-40 hydrogenated | 0.2 | 0.2 | 0.2 | 0.2 | 0.2 | — |
| castor oil | | | | | | |
| Sodium salicylate | 0.4 | 0.4 | 0.4 | 0.4 | 0.4 | 0.2 |
| Sodium benzoate | 0.4 | 0.4 | 0.4 | 0.4 | 0.4 | 0.4 |
| Sodium chloride | 0.9 | 1.0 | 1.2 | — | — | — |
| Citric acid | qs | qs | qs | qs | qs | — |
| Lactic acid | — | — | — | — | — | qs |
| Perfume | qs | qs | qs | qs | qs | qs |
| Water | ad 100 | ad 100 | Ad 100 | ad 100 | ad 100 | ad 100 |

| | Scalp peeling shampoo | | |
|---|---|---|---|
| | 1 | 2 | 3 |
| Sodium lauryl either sulphate | 9 | 9 | 9 |
| Cocoamidopropylbetaine | 4 | 4 | 4 |
| Disodium PEG-5 lauryl citrate sulphosuccinate | 3 | 3 | 3 |
| Acrylate copolymer (Acrylates Copolymer) | 2.0 | 2.0 | 2.0 |
| Polyquaternium-10 | 0.3 | 0.1 | 0.1 |
| Guar hydroxypropyltrimonium chloride | — | — | 0.1 |
| Pearlescene | 1.5 | 3 | 4 |
| Opacifier | — | — | — |
| Iminodisuccinic acid | 0.1 | 0.2 | 0.1 |
| PEG-40 hydrogenated castor oil | 0.2 | 0.2 | 0.2 |
| Unispheres (lactose + cellulose + | — | — | 0.3 |
| hHydroxypropylmethylcellulose + Cl 77007) | | | |
| Polyethylene particles | 0.1 | 0.2 | 0.1 |
| Sodium salicylate | 0.4 | 0.4 | 0.4 |
| Sodium benzoate | 0.4 | 0.4 | 0.4 |
| Sodium chloride | 0.9 | 1.0 | 1.2 |
| Citric acid | qs | qs | qs |
| Perfume | qs | qs | qs |
| Water | ad 100 | ad 100 | ad 100 |

13.) Hairstyling Gel

| | 1 | 2 | 3 |
|---|---|---|---|
| PVP/VA copolymer | 5.0 | 6.0 | 7.0 |
| Carbomer | 0.5 | | 0.8 |
| Acrylate copolymer (Acrylates/C 10-30 | — | 1.0 | — |
| Alkyl Acrylate Crosspolymer) | | | |
| PEG-40 hydrogenated castor oil | 0.2 | 0.2 | 0.2 |
| Silicone oil | — | — | 0.1 |
| Glycerol | 3.0 | — | — |
| NaOH | qs | qs | qs |
| Perfume | 0.3 | 0.3 | 0.3 |
| Ethanol | — | — | 10.0 |
| Water | ad 100 | ad 100 | ad 100 |

14.) Hair Treatments

| | 1 | 2 | 3 |
|---|---|---|---|
| Hydroxypropylmethylcellulose | 0.5 | 0.5 | 0.5 |
| Cetrimonium bromide | 1.0 | — | 0.8 |
| Behentrimonium chloride | — | 0.7 | 0.3 |
| Glycerol | 3.0 | 3.0 | 3.0 |
| Cetearyl alcohol | 2.5 | 2.5 | 2.5 |
| Glyceryl stearate | 2.0 | 2.0 | 2.0 |
| Polyquaternium-10 | 0.1 | — | — |
| Guar hydroxypropyltrimonium chloride | — | 0.2 | — |
| Panthenol | 0.2 | 0.5 | 0.3 |
| Preservative, perfume, pH regulator and | qs | qs | qs |
| solubility promoter | | | |
| Water | ad 100 | ad 100 | ad 100 |

15.) Hair Rinses

| | 1 | 2 | 3 |
|---|---|---|---|
| Cetrimonium chloride | 1.0 | 0.5 | 0.5 |
| Behentrimonium chloride | — | 0.2 | 0.3 |
| Glycerol | 3.0 | 3.0 | 3.0 |
| Hydroxyethylcellulose | 0.2 | 0.2 | 0.2 |
| Polyquaternium-10 | 0.1 | — | — |
| Guar hydroxypropyltrimonium chloride | — | 0.2 | — |
| Jojoba oil | 0.2 | 0.3 | 0.1 |
| Preservative, perfume, pH regulator and | qs | qs | qs |
| solubility promoter | | | |
| Water | ad 100 | ad 100 | ad 100 |

16.) Leave-On Conditioner

| | 1 | 2 | 3 | 4 |
|---|---|---|---|---|
| Cetyl alcohol | 1.5 | 1.8 | 2.0 | — |
| Cetrimonium chloride | 0.3 | 0.1 | 0.5 | 0.5 |
| Behentrimonium chloride | — | 0.2 | — | — |
| Benzophenone-4 | 0.05 | 0.03 | — | 0.1 |
| PVP/VA copolymer | 0.4 | — | — | — |
| Polyquaternium-37 | — | — | — | 1.0 |
| Polyquaternium-4 | — | — | — | 0.2 |
| Polyquaternium-10 | — | — | 0.5 | — |
| Panthenol | 0.1 | — | 0.2 | 0.1 |
| Hydroxyethylcellulose | — | — | — | 0.3 |
| Acrylates/C10-30 | 0.5 | 0.3 | 0.2 | — |
| Alkyl Acrylates | | | | |
| Crosspolymer | | | | |
| C12-13 Alkyl Lactate | 2.0 | 1.0 | 1.5 | 1.0 |
| Laureth-4 | — | — | — | 0.5 |
| Aluminium Starch | — | — | — | 1.0 |
| Octenylsuccinate | | | | |
| Dicaprylyl Carbonate | — | — | — | 1.0 |
| Preservative, perfume, | qs | qs | qs | qs |
| pH regulator and | | | | |
| solubility promoter | | | | |
| Water | ad 100 | ad 100 | ad 100 | ad 100 |

1. A cosmetic or dermatological product, comprising:
(a) a dispenser comprising:
a container and an inner container wall for housing a cosmetic or dermatological preparation;
a follow-up plunger on a base side of the dispenser, which is capable of being slidably displaced on the inner container wall under the pressure of the ambient atmosphere;
a head section on a top end of the dispenser that can be slidably displaced in relation to the container and that comprises a dispensing channel, the dispensing channel capable of being connected in a communicating manner to the container;
a manually actuable delivery device comprising:
a variable-volume delivery chamber,
a delivery element that can be displaced longitudinally in relation to the container and the head section, comprising a delivery plunger that can be slidably displaced within the delivery chamber and a delivery stem connected to the delivery plunger, and
a delivery channel circumferentially enclosed by the delivery stem and comprising a delivery-channel inlet opening communicating with the delivery chamber and a delivery-channel outlet opening, the delivery channel outlet opening capable of being moved into an open position relative to the dispensing channel by displacing said delivery element; and
(b) a cosmetic or dermatological preparation comprising at least 0.01% by weight of one or more hydrocolloids and provided in said container.

2. The cosmetic or dermatological product according to claim 1, wherein the delivery-channel outlet opening is on the circumferential surface of the delivery stem and the head section has a bushing that covers the delivery-channel outlet opening in the starting position of the delivery device.

3. The cosmetic or dermatological product according to claim 2, wherein the bushing is designed as a guide bushing that guides the delivery device in a longitudinally displaceable manner and has at least one guide surface interacting with the circumferential surface of the delivery stem.

4. The cosmetic or dermatological product according to claim 3, wherein the delivery plunger projects radially beyond the delivery stem to form an annular abutment surface and the guide bushing has an end-side pressure-exerting surface which, in the starting position, is spaced apart axially from the abutment surface and, by virtue of the head section being displaced axially in the direction of the container, can be positioned on the abutment surface.

5. The cosmetic or dermatological product according to claim 2, wherein carry-along means are provided on the head section and on the delivery device and carry along the delivery device into the starting position following manual actuation when the head section is returned.

6. The cosmetic or dermatological product according to claim 5, wherein a carry-along shoulder is formed on the bushing and interacts with a carry-along ring integrally formed on the delivery stem.

7. The cosmetic or dermatological product according to claim 6, wherein the carry-along shoulder is provided at the end of the bushing at the transition to the dispensing channel, and the carry-along ring is provided in the end region of the delivery stem.

8. The cosmetic or dermatological product according to claim 1, wherein the inner wall of the delivery chamber is formed by an inner sleeve which is provided on the head-section end side of the container.

9. The cosmetic or dermatological product according to claim 8, further comprising a mating head section that includes a retaining cylinder that is fitted in a cup-like manner onto the inner sleeve and a guide cylinder that is arranged concentrically in relation to the retaining cylinder and that guides the sliding displacement of the head section.

10. The cosmetic or dermatological product according to claim 9, whrein the delivery-chamber end of the guide cylinder has a stop for the delivery plunger.

11. The cosmetic or dermatological product according to claim 9, wherein the retaining cylinder is provided with a base-side annular shoulder that forms an abutment surface for a helical spring, retaining the head section under prestressing in the starting position, and is positioned on the end side of the container.

12. The cosmetic or dermatological product according to claim 9, wherein the mating head section has at least one stop for limiting the axial displacement movement of the head section and is formed, together with the head section, as a prefabricated dispenser component and is fastened on the end side of the container.

13. The cosmetic or dermatological product according to claim 12, wherein the dispenser component is latched to the container via latching means formed on the mating head section and the end side of the container.

14. The cosmetic or dermatological product according to claim 1, wherein the head section can be displaced longitudinally such that it can be moved by means of manual actuation from the starting position, in the first instance by a first axial distance in order to butt against the delivery plunger, into a central position, with simultaneous exposure of the delivery-channel outlet opening in the dispensing channel, and it can then be moved, upon continued axial displacement, with the delivery plunger being carried along, from the central position into a final dispensing position, in which the the volume of the delivery chamber is reduced by virtue of displacement of the delivery plunger.

15. The cosmetic or dermatological product according to claim 1, further comprising a closure part that is fastened on the head part and by means of which a product-discharge opening of the dispensing channel can be closed.

16. The cosmetic or dermatological product according to claim 15, wherein the product-discharge opening is formed annularly around a closure pin arranged in the dispensing channel, and wherein the closure part has an annular sealing lip that can be positioned for sealing action on the closure pin.

17. The cosmetic or dermatological product according to claim 15, wherein the closure part is formed from a soft, resilient plastic material.

18. The cosmetic or dermatological product according to claim 17, wherein the closure part is formed from a thermoplastic elastomer.

19. The cosmetic or dermatological product according to claim 15, wherein the closure part is integral with a coating formed at least on the end side of the exterior of the head part.

20. The cosmetic or dermatological product according to claim 1, wherein the one ore more hydrocolloids include one or more hydrocolloids selected from the group consisting of water-soluble polysaccharides and derivatives thereof.

21. The cosmetic or dermatological product according to claim 1, wherein the one ore more hydrocolloids include one or more hydrocolloids selected from the group consisting of water-soluble celluloses and derivatives thereof.

22. The cosmetic or dermatological product according to claim 1, wherein the one ore more hydrocolloids include one or more hydrocolloids selected from the group consisting of water-soluble polyacrylic acids, semi-synthetic copolymers and crosspolymers of water-soluble polyacrylic acids, and synthetic copolymers and crosspolymers of water-soluble polyacrylic acids.

23. The cosmetic or dermatological product according to claim 1, wherein the one ore more hydrocolloids are present in an amount from 0.01% by weight to 5% by weight, based on the total weight of the preparation.

24. The cosmetic or dermatological product according to claim 1, wherein the one ore more hydrocolloids are present in an amount from 0.1% by weight to 3% by weight, based on the total weight of the preparation.

25. The cosmetic or dermatological product according to claim 1, wherein the one ore more hydrocolloids are present in an amount from 0.15% by weight to 1.5% by weight, based on the total weight of the preparation.

26. The cosmetic or dermatological product according to claim 1. wherein the one or more hydrocolloids include one or more hydrocolloids selected from the group consisting of polyacrylic acid, acrylate copolymer, alkyl acrylate crosspolymer, ammonium dimethyltauramide/vinylformamide copolymer, polyacrylamide, sheet silicate, xanthan gum and carrageenan.

27. The cosmetic or dermatological product according to claim 1. wherein the one or more hydrocolloids include a mixture of at least two different hydrocolloids.

28. The cosmetic or dermatological product according to claim 27. wherein the mixture of at least two different hydrocolloids include the following mixtures:
xanthan gum and a sheet silicate;
xanthan gum and a polyacrylic acid;
a sheet silicate and a polyacrylic acid;
a cellulose derivative and a polyacrylic acid;
a cellulose derivative and a sheet silicate;
an ammonium dimethyltauramide/vinylformamide copolymer and a polyacrylate;
an ammonium dimethyltauramide/vinylformamide copolymer and a polyacrylamide;
a xantham gum, a polyacrylic acid and a cellulose derivative;
a C10-30 alkyl acrylate crosspolymer and xanthan gum;
a carbomer and xanthan gum; and
2 different carbomers.

29. The cosmetic or dermatological product according to claim 1, wherein the viscosity change of the preparation before and after the shearing action associated with dispensing the product is less than 75%.

30. A dispensable cosmetic or dermatological preparation, comprising at least 0.01% by weight of one or more hydrocolloids.

31. The cosmetic or dermatological preparation according to claim 30, wherein the one ore more hydrocolloids include one or more hydrocolloids selected from the group consisting of water-soluble polysaccharides and derivatives thereof.

32. The cosmetic or dermatological preparation according to claim 30, wherein the one ore more hydrocolloids include one or more hydrocolloids selected from the group consisting of water-soluble celluloses and derivatives thereof.

33. The cosmetic or dermatological preparation according to claim 30, wherein the one ore more hydrocolloids include one or more hydrocolloids selected from the group consisting of water-soluble polyacrylic acids, semi-synthetic copolymers and crosspolymers of water-soluble polyacrylic acids, and synthetic copolymers and crosspolymers of water-soluble polyacrylic acids.

34. The cosmetic or dermatological preparation according to claim 30, wherein the one ore more hydrocolloids are present in an amount from 0.01% by weight to 5% by weight, based on the total weight of the preparation.

35. The cosmetic or dermatological preparation according to claim 30, wherein the one ore more hydrocolloids are present in an amount from 0.1% by weight to 3% by weight, based on the total weight of the preparation.

36. The cosmetic or dermatological preparation according to claim 30, wherein the one ore more hydrocolloids are present in an amount from 0.15% by weight to 1.5% by weight, based on the total weight of the preparation.

37. The cosmetic or dermatological preparation according to claim 30. wherein the one or more hydrocolloids include one or more hydrocolloids selected from the group consisting of polyacrylic acid, acrylate copolymer, alkyl acrylate crosspolymer, ammonium dimethyltauramide/vinylformamide copolymer, polyacrylamide, sheet silicate, xanthan gum and carrageenan.

38. The cosmetic or dermatological preparation according to claim 30. wherein the one or more hydrocolloids include a mixture of at least two different hydrocolloids.

39. The cosmetic or dermatological preparation according to claim 38, wherein the mixture of at least two different hydrocolloids include the following mixtures:
xanthan gum and a sheet silicate;
xanthan gum and a polyacrylic acid;
a sheet silicate and a polyacrylic acid;
a cellulose derivative and a polyacrylic acid;
a cellulose derivative and a sheet silicate;
an ammonium dimethyltauramide/vinylformamide copolymer and a polyacrylate;
an ammonium dimethyltauramide/vinylformamide copolymer and a polyacrylamide;
a xantham gum, a polyacrylic acid and a cellulose derivative;
a C10-30 alkyl acrylate crosspolymer and xanthan gum;
a carbomer and xanthan gum; and
2 different carbomers.

40. A method for preventing a loss in structure of a cosmetic or dermatological preparation as it is removed from a dispenser system in which the preparation is subjected to a shearing action during removal, comprising adding to the cosmetic or dermatological preparation at least 0.01% by weight of one or more hydrocolloids.

41. The method according to claim 40, wherein the viscosity change in the preparation brought about by the shearing action is less than 75%.

42. A dispenser for dispensing a cosmetic or dermatological prepartion, comprising:
a container and an inner container wall for housing a cosmetic or dermatological preparation;
a follow-up plunger on a base side of the dispenser, which is capable of being slidably displaced on the inner container wall under the pressure of the ambient atmosphere;
a head section on a top end of the dispenser that can be slidably displaced in relation to the container and that comprises a dispensing channel, the dispensing channel capable of being connected in a communicating manner to the container;
a manually actuable delivery device comprising:
a variable-volume delivery chamber,
a delivery element that can be displaced longitudinally in relation to the container and the head section, comprising a delivery plunger that can be slidably displaced within the delivery chamber and a delivery stem connected to the delivery plunger, and
a delivery channel circumferentially enclosed by the delivery stem and comprising a delivery-channel inlet opening communicating with the delivery chamber and a delivery-channel outlet opening, the delivery channel outlet opening capable of being moved into an open position relative to the dispensing channel by displacing said delivery element.
